(19) United States
(12) Patent Application Publication
(10) Pub. No.: US 2013/0006718 A1
(43) Pub. Date: Jan. 3, 2013

(54) METHODS, APPARATUS AND SYSTEMS FOR CHRONICLING THE ACTIVITIES OF FIELD TECHNICIANS

(75) Inventors: Steven Nielsen, North Palm Beach, FL (US); Curtis Chambers, Palm Beach Gardens, FL (US); Jeffrey Farr, Tequesta, FL (US)

(73) Assignee: CertusView Technologies, LLC

(21) Appl. No.: 13/465,524

(22) Filed: May 7, 2012

Related U.S. Application Data
(60) Provisional application No. 61/503,925, filed on Jul. 1, 2011.

(51) Int. Cl. G06Q 10/06

(52) U.S. Cl. 705/7.42; 705/7.38

(57) ABSTRACT

Tracking or monitoring activities associated with employees, such as field technicians working in the field, is based on receiving and processing activity information related to activities conducted by the employees. Activity information may include location information associated with individual activities or equipment, employee status information (e.g. clocked-in or clocked-out), travel information, or other information associated with an employee's activities. In an example, tracking employee activities may include receiving field service activity information, associating at least one data source with at least one technician, associating an acquisition event with at least one time window and at least one location, and generating a timeline associated with the at least one technician and at least one data source, where generating the timeline includes reconciling the acquisition event with the received field service activity information.

### RELATED APPLICATIONS

This application claims the benefit, under 35 U.S.C. §119(e), of U.S. Provisional Patent Application No. 61/503,925, filed Jul. 1, 2011, under Atty. Docket No. 098689-0366 (DYC0081US00), entitled “Methods, Apparatus and Systems for Chronicling the Activities of Field Technicians,” which application is hereby incorporated herein by reference.

### BACKGROUND

Tracking or monitoring employee activities is a challenging task when employees are performing various functions at job sites in the field. Each employee may have different tasks based on their title or role and may have tasks that need to be performed in different geographic areas. For example, technicians may perform work in the field at various job sites, and supervisors and managers may review the technicians' work at a job site or from an office. Employees conventionally may document their time manually using physical or electronic timesheets. However, such methods require the employee to accurately track and record their clock-in time, clock-out time, time spent on each task, and other details related to their work day.

### SUMMARY

The inventors have recognized and appreciated that a process of employee time-keeping involving manually completed time sheets may be time-consuming and difficult for an employee to effectively audit for overall accuracy. Similarly, when employees are at job sites performing tasks assigned in their work orders, ensuring that work is performed with the correct equipment and in the correct locations at the job site is a challenging task that would require employees to document every piece of equipment used, the time the equipment was used, and the exact location where the equipment was used.

Additionally, employees are often subject to wage and hours guidelines that prescribe details relating to how long employees can work without breaks, how many breaks need to be provided, and other details related to an employee's work day. Different jurisdictions may have different guidelines, so an employer/company must identify and comply with the appropriate guidelines based on the geographic area in which the employee and/or the company are operating. Also, verifying employees' entries related to such guidelines may be difficult without independent record-keeping regarding their activities throughout the work day.

In view of the foregoing, various inventive embodiments disclosed herein relate generally to methods, apparatus and systems for chronicling the activities of field technicians. More specifically, aspects of the present invention provide information regarding the activities of technicians on the way to and during service jobs, which mitigates abuse of timekeeping and billing activities. Embodiments of the present invention may include receiving and processing data from data sources associated with scheduled activities of individual technicians throughout a work day. Additional embodiments may include tracking or monitoring aspects of the technician's activities to validate activity information based on received location information such as coordinate data or image data associated with field technicians. Another aspect relates to correlating and/or monitoring actual field service activity with respect to expected field service activity based on work order assignments associated with field service personnel or technicians.

One embodiment implementing the various concepts disclosed herein relates to an “activity tracking system.” One aspect of an activity tracking system according to one embodiment of the present disclosure includes tying timekeeping activity to real-time geo-location information. For example, the activity tracking system may associate and log clock in/out activity with image data, such as one or more geo-encoded images associated with the location of a field technician or job site based at least in part on determined location information. Images may be retrieved and processed from various sources, such as satellite image sources, aerial image sources, or other accessible sources (e.g., street maps, facility maps, engineering plans, blueprints, tax maps, or surveys) configured to provide image data related to specified locations or coordinates associated with technicians' activities.

Another aspect of an activity tracking system according to one embodiment of the present disclosure includes prompting technicians to confirm activities performed and/or explain discrepancies between actual field service activity and expected field service activity, thereby significantly reducing time reporting abuses by field service personnel.

The following U.S. patent and published applications are hereby incorporated herein by reference:

U.S. Pat. No. 7,640,105, issued Dec. 29, 2009, filed Mar. 13, 2007, and entitled “Marking System and Method With Location and/or Time Tracking;”

U.S. publication no. 2010-0094553-A1, published Apr. 15, 2010, filed Dec. 16, 2009, and entitled “Systems and Methods for Using Location Data and/or Time Data to Electronically Display Dispensing of Markers by A Marking System or Marking Tool;”

U.S. publication no. 2008-0245299-A1, published Oct. 9, 2008, filed Apr. 4, 2007, and entitled “Marking System and Method;”

U.S. publication no. 2009-0013928-A1, published Jan. 15, 2009, filed Sep. 24, 2008, and entitled “Marking System and Method;”

U.S. publication no. 2010-0090858-A1, published Apr. 15, 2010, filed Dec. 16, 2009, and entitled “Systems and Methods for Using Marking Information to Electronically Display Dispensing of Markers by a Marking System or Marking Tool;”

U.S. publication no. 2009-0238414-A1, published Sep. 24, 2009, filed Mar. 18, 2008, and entitled “Virtual White Lines for Delimiting Planned Excavation Sites;”

U.S. publication no. 2009-0241045-A1, published Sep. 24, 2009, filed Sep. 26, 2008, and entitled “Virtual White Lines for Delimiting Planned Excavation Sites;”

U.S. publication no. 2009-0238415-A1, published Sep. 24, 2009, filed Sep. 26, 2008, and entitled “Virtual White Lines for Delimiting Planned Excavation Sites;”

U.S. publication no. 2009-0241046-A1, published Sep. 24, 2009, filed Jan. 16, 2009, and entitled “Virtual White Lines for Delimiting Planned Excavation Sites;”

U.S. publication no. 2009-0238416-A1, published Sep. 24, 2009, filed Jan. 16, 2009, and entitled “Virtual White Lines for Delimiting Planned Excavation Sites;”

U.S. publication no. 2009-0237408-A1, published Sep. 24, 2009, filed Jan. 16, 2009, and entitled “Virtual White Lines for Delimiting Planned Excavation Sites;”

U.S. publication no. 2011-0135163-A1, published Jun. 9, 2011, filed Feb. 16, 2011, and entitled “Methods and Apparatus for Providing Unbuffered Dig Area Indicators on Aerial Images to Delimit Planned Excavation Sites;”

U.S. publication no. 2009-0202101-A1, published Aug. 13, 2009, filed Feb. 12, 2008, and entitled “Electronic Manifest of Underground Facility Locate Marks;”

U.S. publication no. 2009-0202110-A1, published Aug. 13, 2009, filed Sep. 11, 2008, and entitled “Electronic Manifest of Underground Facility Locate Marks;”

U.S. publication no. 2009-0201311-A1, published Aug. 13, 2009, filed Jan. 30, 2009, and entitled “Electronic Manifest of Underground Facility Locate Marks;”

U.S. publication no. 2009-0202111-A1, published Aug. 13, 2009, filed Jan. 30, 2009, and entitled “Electronic Manifest of Underground Facility Locate Marks;”

U.S. publication no. 2009-0204625-A1, published Aug. 13, 2009, filed Feb. 5, 2009, and entitled “Electronic Manifest of Underground Facility Locate Operation;”

U.S. publication no. 2009-0204466-A1, published Aug. 13, 2009, filed Sep. 4, 2008, and entitled “Ticket Approval System For and Method of Performing Quality Control In Field Service Applications;”

U.S. publication no. 2009-0207019-A1, published Aug. 20, 2009, filed Apr. 30, 2009, and entitled “Ticket Approval System For and Method of Performing Quality Control In Field Service Applications;”

U.S. publication no. 2009-0210284-A1, published Aug. 20, 2009, filed Apr. 30, 2009, and entitled “Ticket Approval System For and Method of Performing Quality Control In Field Service Applications;”

U.S. publication no. 2009-0210297-A1, published Aug. 20, 2009, filed Apr. 30, 2009, and entitled “Ticket Approval System For and Method of Performing Quality Control In Field Service Applications;”

U.S. publication no. 2009-0210298-A1, published Aug. 20, 2009, filed Apr. 30, 2009, and entitled “Ticket Approval System For and Method of Performing Quality Control In Field Service Applications;”

U.S. publication no. 2009-0210285-A1, published Aug. 20, 2009, filed Apr. 30, 2009, and entitled “Ticket Approval System For and Method of Performing Quality Control In Field Service Applications;”

U.S. publication no. 2009-0324815-A1, published Dec. 31, 2009, filed Apr. 24, 2009, and entitled “Marking Apparatus and Marking Methods Using Marking Dispenser with Machine-Readable ID Mechanism;”

U.S. publication no. 2010-0006667-A1, published Jan. 14, 2010, filed Apr. 24, 2009, and entitled, “Marker Detection Mechanisms for use in Marking Devices And Methods of Using Same;”

U.S. publication no. 2010-0085694 A1, published Apr. 8, 2010, filed Sep. 30, 2009, and entitled, “Marking Device Docking Stations and Methods of Using Same;”

U.S. publication no. 2010-0085701 A1, published Apr. 8, 2010, filed Sep. 30, 2009, and entitled, “Marking Device Docking Stations Having Security Features and Methods of Using Same;”

U.S. publication no. 2010-0084532 A1, published Apr. 8, 2010, filed Sep. 30, 2009, and entitled, “Marking Device Docking Stations Having Mechanical Docking and Methods of Using Same;”

U.S. publication no. 2010-0088032-A1, published Apr. 8, 2010, filed Sep. 29, 2009, and entitled, “Methods, Apparatus and Systems for Generating Electronic Records of Locate And Marking Operations, and Combined Locate and Marking Apparatus for Same;”

U.S. publication no. 2010-0117654 A1, published May 13, 2010, filed Dec. 30, 2009, and entitled, “Methods and Apparatus for Displaying an Electronic Rendering of a Locate and/or Marking Operation Using Display Layers;”

U.S. publication no. 2010-0086677 A1, published Apr. 8, 2010, filed Aug. 11, 2009, and entitled, “Methods and Apparatus for Generating an Electronic Record of a Marking Operation Including Service-Related Information and Ticket Information;”

U.S. publication no. 2010-0086671 A1, published Apr. 8, 2010, filed Nov. 20, 2009, and entitled, “Methods and Apparatus for Generating an Electronic Record of A Marking Operation Including Service-Related Information and Ticket Information;”

U.S. publication no. 2010-0085376 A1, published Apr. 8, 2010, filed Oct. 28, 2009, and entitled, “Methods and Apparatus for Displaying an Electronic Rendering of a Marking Operation Based on an Electronic Record of Marking Information;”

U.S. publication no. 2010-0088164-A1, published Apr. 8, 2010, filed Sep. 30, 2009, and entitled, “Methods and Apparatus for Analyzing Locate and Marking Operations with Respect to Facilities Maps;”

U.S. publication no. 2010-0088134 A1, published Apr. 8, 2010, filed Oct. 1, 2009, and entitled, “Methods and Apparatus for Analyzing Locate and Marking Operations with Respect to Historical Information;”

U.S. publication no. 2010-0088031 A1, published Apr. 8, 2010, filed Sep. 28, 2009, and entitled, “Methods and Apparatus for Generating an Electronic Record of Environmental Landmarks Based on Marking Device Actuations;”

U.S. publication no. 2010-0188407 A1, published Jul. 29, 2010, filed Feb. 5, 2010, and entitled “Methods and Apparatus for Displaying and Processing Facilities Map Information and/or Other Image Information on a Marking Device;”

U.S. publication no. 2010-0198663 A1, published Aug. 5, 2010, filed Feb. 5, 2010, and entitled “Methods and Apparatus for Overlaying Electronic Marking Information on Facilities Map Information and/or Other Image Information Displayed on a Marking Device;”

U.S. publication no. 2010-0188215 A1, published Jul. 29, 2010, filed Feb. 5, 2010, and entitled “Methods and Apparatus for Generating Alerts on a Marking Device, Based on Comparing Electronic Marking Information to Facilities Map Information and/or Other Image Information;”

U.S. publication no. 2010-0188088 A1, published Jul. 29, 2010, filed Feb. 5, 2010, and entitled “Methods and Apparatus for Displaying and Processing Facilities Map Information and/or Other Image Information on a Locate Device;”

U.S. publication no. 2010-0189312 A1, published Jul. 29, 2010, filed Feb. 5, 2010, and entitled “Methods and Apparatus for Overlaying Electronic Locate Information on Facilities Map Information and/or Other Image Information Displayed on a Locate Device;”

U.S. publication no. 2010-0188216 A1, published Jul. 29, 2010, filed Feb. 5, 2010, and entitled “Methods and Apparatus for Generating Alerts on a Locate Device, Based ON Comparing Electronic Locate Information TO Facilities Map Information and/or Other Image Information;”

U.S. publication no. 2010-0189887 A1, published Jul. 29, 2010, filed Feb. 11, 2010, and entitled “Marking Apparatus Having Enhanced Features for Underground Facility Marking Operations, and Associated Methods and Systems;”

U.S. publication no. 2010-0256825-A1, published Oct. 7, 2010, filed Jun. 9, 2010, and entitled “Marking Apparatus Having Operational Sensors For Underground Facility Marking Operations, And Associated Methods And Systems;”

U.S. publication no. 2010-0255182-A1, published Oct. 7, 2010, filed Jun. 9, 2010, and entitled “Marking Apparatus Having Operational Sensors For Underground Facility Marking Operations, And Associated Methods And Systems;”

U.S. publication no. 2010-0245086-A1, published Sep. 30, 2010, filed Jun. 9, 2010, and entitled “Marking Apparatus Configured To Detect Out-Of-Tolerance Conditions In Connection With Underground Facility Marking Operations, And Associated Methods And Systems;”

U.S. publication no. 2010-0247754-A1, published Sep. 30, 2010, filed Jun. 9, 2010, and entitled “Methods and Apparatus For Dispensing Marking Material In Connection With Underground Facility Marking Operations Based on Environmental Information and/or Operational Information;”

U.S. publication no. 2010-0262470-A1, published Oct. 14, 2010, filed Jun. 9, 2010, and entitled “Methods, Apparatus, and Systems For Analyzing Use of a Marking Device By a Technician To Perform An Underground Facility Marking Operation;”

U.S. publication no. 2010-0263591-A1, published Oct. 21, 2010, filed Jun. 9, 2010, and entitled “Marking Apparatus Having Environmental Sensors and Operations Sensors for Underground Facility Marking Operations, and Associated Methods and Systems;”

U.S. publication no. 2010-0188245 A1, published Jul. 29, 2010, filed Feb. 11, 2010, and entitled “Locate Apparatus Having Enhanced Features for Underground Facility Locate Operations, and Associated Methods and Systems;”

U.S. publication no. 2010-0253511-A1, published Oct. 7, 2010, filed Jun. 18, 2010, and entitled “Locate Apparatus Configured to Detect Out-of-Tolerance Conditions in Connection with Underground Facility Locate Operations, and Associated Methods and Systems;”

U.S. publication no. 2010-0257029-A1, published Oct. 7, 2010, filed Jun. 18, 2010, and entitled “Methods, Apparatus, and Systems For Analyzing Use of a Locate Device By a Technician to Perform an Underground Facility Locate Operation;”

U.S. publication no. 2010-0253513-A1, published Oct. 7, 2010, filed Jun. 18, 2010, and entitled “Locate Transmitter Having Enhanced Features For Underground Facility Locate Operations, and Associated Methods and Systems;”

U.S. publication no. 2010-0253514-A1, published Oct. 7, 2010, filed Jun. 18, 2010, and entitled “Locate Transmitter Configured to Detect Out-of-Tolerance Conditions In Connection With Underground Facility Locate Operations, and Associated Methods and Systems;”

U.S. publication no. 2010-0256912-A1, published Oct. 7, 2010, filed Jun. 18, 2010, and entitled “Locate Apparatus for Receiving Environmental Information Regarding Underground Facility Marking Operations, and Associated Methods and Systems;”

U.S. publication no. 2009-0204238-A1, published Aug. 13, 2009, filed Feb. 2, 2009, and entitled “Electronically Controlled Marking Apparatus and Methods;”

U.S. publication no. 2009-0208642-A1, published Aug. 20, 2009, filed Feb. 2, 2009, and entitled “Marking Apparatus and Methods For Creating an Electronic Record of Marking Operations;”

U.S. publication no. 2009-0210098-A1, published Aug. 20, 2009, filed Feb. 2, 2009, and entitled “Marking Apparatus and Methods For Creating an Electronic Record of Marking Apparatus Operations;”

U.S. publication no. 2009-0201178-A1, published Aug. 13, 2009, filed Feb. 2, 2009, and entitled “Methods For Evaluating Operation of Marking Apparatus;”

U.S. publication no. 2009-0238417-A1, published Sep. 24, 2009, filed Feb. 6, 2009, and entitled “Virtual White Lines for Indicating Planned Excavation Sites on Electronic Images;”

U.S. publication no. 2010-0205264-A1, published Aug. 12, 2010, filed Feb. 10, 2010, and entitled “Methods, Apparatus, and Systems for Exchanging Information Between Excavators and Other Entities Associated with Underground Facility Locate and Marking Operations;”

U.S. publication no. 2010-0205031-A1, published Aug. 12, 2010, filed Feb. 10, 2010, and entitled “Methods, Apparatus, and Systems for Exchanging Information Between Excavators and Other Entities Associated with Underground Facility Locate and Marking Operations;”

U.S. publication no. 2010-0259381-A1, published Oct. 14, 2010, filed Jun. 28, 2010, and entitled “Methods, Apparatus and Systems for Notifying Excavators and Other Entities of the Status of in-Progress Underground Facility Locate and Marking Operations;”

U.S. publication no. 2010-0262670-A1, published Oct. 14, 2010, filed Jun. 28, 2010, and entitled “Methods, Apparatus and Systems for Communicating Information Relating to the Performance of Underground Facility Locate and Marking Operations to Excavators and Other Entities;”

U.S. publication no. 2010-0259414-A1, published Oct. 14, 2010, filed Jun. 28, 2010, and entitled “Methods, Apparatus And Systems For Submitting Virtual White Line Drawings And Managing Notifications In Connection With Underground Facility Locate And Marking Operations;”

U.S. publication no. 2010-0268786-A1, published Oct. 21, 2010, filed Jun. 28, 2010, and entitled “Methods, Apparatus and Systems for Requesting Underground Facility Locate and Marking Operations and Managing Associated Notifications;”

U.S. publication no. 2010-0201706-A1, published Aug. 12, 2010, filed Jun. 1, 2009, and entitled “Virtual White Lines (VWL) for Delimiting Planned Excavation Sites of Staged Excavation Projects;”

U.S. publication no. 2010-0205555-A1, published Aug. 12, 2010, filed Jun. 1, 2009, and entitled “Virtual White Lines (VWL) for Delimiting Planned Excavation Sites of Staged Excavation Projects;”

U.S. publication no. 2010-0205195-A1, published Aug. 12, 2010, filed Jun. 1, 2009, and entitled “Methods and Apparatus for Associating a Virtual White Line (VWL) Image with Corresponding Ticket Information for an Excavation Project;”

U.S. publication no. 2010-0205536-A1, published Aug. 12, 2010, filed Jun. 1, 2009, and entitled “Methods and Apparatus for Controlling Access to a Virtual White Line (VWL) Image for an Excavation Project;”

U.S. publication no. 2010-0228588-A1, published Sep. 9, 2010, filed Feb. 11, 2010, and entitled “Management System, and Associated Methods and Apparatus, for Providing Improved Visibility, Quality Control and Audit Capability for Underground Facility Locate and/or Marking Operations;”

U.S. publication no. 2010-0324967-A1, published Dec. 23, 2010, filed Jul. 9, 2010, and entitled “Management System, and Associated Methods and Apparatus, for Dispatching Tickets, Receiving Field Information, and Performing A Quality Assessment for Underground Facility Locate and/or Marking Operations;”

U.S. publication no. 2010-0318401-A1, published Dec. 16, 2010, filed Jul. 9, 2010, and entitled “Methods and Apparatus for Performing Locate and/or Marking Operations with Improved Visibility, Quality Control and Audit Capability;”

U.S. publication no. 2010-0318402-A1, published Dec. 16, 2010, filed Jul. 9, 2010, and entitled “Methods and Apparatus for Managing Locate and/or Marking Operations;”

U.S. publication no. 2010-0318465-A1, published Dec. 16, 2010, filed Jul. 9, 2010, and entitled “Systems and Methods for Managing Access to Information Relating to Locate and/or Marking Operations;”

U.S. publication no. 2010-0201690-A1, published Aug. 12, 2010, filed Apr. 13, 2009, and entitled “Virtual White Lines (VWL) Application for Indicating a Planned Excavation or Locate Path;”

U.S. publication no. 2010-0205554-A1, published Aug. 12, 2010, filed Apr. 13, 2009, and entitled “Virtual White Lines (VWL) Application for Indicating an Area of Planned Excavation;”

U.S. publication no. 2009-0202112-A1, published Aug. 13, 2009, filed Feb. 11, 2009, and entitled “Searchable Electronic Records of Underground Facility Locate Marking Operations;”

U.S. publication no. 2009-0204614-A1, published Aug. 13, 2009, filed Feb. 11, 2009, and entitled “Searchable Electronic Records of Underground Facility Locate Marking Operations;”

U.S. publication no. 2011-0060496-A1, published Mar. 10, 2011, filed Aug. 10, 2010, and entitled “Systems and Methods for Complex Event Processing of Vehicle Information and Image Information Relating to a Vehicle.;”

U.S. publication no. 2011-0093162-A1, published Apr. 21, 2011, filed Dec. 28, 2010, and entitled “Systems And Methods For Complex Event Processing Of Vehicle-Related Information;”

U.S. publication no. 2011-0093306-A1, published Apr. 21, 2011, filed Dec. 28, 2010, and entitled “Fleet Management Systems And Methods For Complex Event Processing Of Vehicle-Related Information Via Local And Remote Complex Event Processing Engines;”

U.S. publication no. 2011-0093304-A1, published Apr. 21, 2011, filed Dec. 29, 2010, and entitled “Systems And Methods For Complex Event Processing Based On A Hierarchical Arrangement Of Complex Event Processing Engines;”

U.S. publication no. 2010-0257477-A1, published Oct. 7, 2010, filed Apr. 2, 2010, and entitled “Methods, Apparatus, and Systems for Documenting and Reporting Events Via Time-Elapsed Geo-Referenced Electronic Drawings;”

U.S. publication no. 2010-0256981-A1, published Oct. 7, 2010, filed Apr. 2, 2010, and entitled “Methods, Apparatus, and Systems for Documenting and Reporting Events Via Time-Elapsed Geo-Referenced Electronic Drawings;”

U.S. publication no. 2010-0205032-A1, published Aug. 12, 2010, filed Feb. 11, 2010, and entitled “Marking Apparatus Equipped with Ticket Processing Software for Facilitating Marking Operations, and Associated Methods;”

U.S. publication no. 2011-0035251-A1, published Feb. 10, 2011, filed Jul. 15, 2010, and entitled “Methods, Apparatus, and Systems for Facilitating and/or Verifying Locate and/or Marking Operations;”

U.S. publication no. 2011-0035328-A1, published Feb. 10, 2011, filed Jul. 15, 2010, and entitled “Methods, Apparatus, and Systems for Generating Technician Checklists for Locate and/or Marking Operations;”

U.S. publication no. 2011-0035252-A1, published Feb. 10, 2011, filed Jul. 15, 2010, and entitled “Methods, Apparatus, and Systems for Processing Technician Checklists for Locate and/or Marking Operations;”

U.S. publication no. 2011-0035324-A1, published Feb. 10, 2011, filed Jul. 15, 2010, and entitled “Methods, Apparatus, and Systems for Generating Technician Workflows for Locate and/or Marking Operations;”

U.S. publication no. 2011-0035245-A1, published Feb. 10, 2011, filed Jul. 15, 2010, and entitled “Methods, Apparatus, and Systems for Processing Technician Workflows for Locate and/or Marking Operations;”

U.S. publication no. 2011-0035260-A1, published Feb. 10, 2011, filed Jul. 15, 2010, and entitled “Methods, Apparatus, and Systems for Quality Assessment of Locate and/or Marking Operations Based on Process Guides;”

U.S. publication no. 2011-0282542-A9, published Nov. 11, 2011, filed Apr. 2, 2010, and entitled “Methods, Apparatus, and Systems for Acquiring and Analyzing Vehicle Data and Generating an Electronic Representation of Vehicle Operations;”

U.S. publication no. 2010-0256863-A1, published Oct. 7, 2010, filed Apr. 2, 2010, and entitled “Methods, Apparatus, and Systems for Acquiring and Analyzing Vehicle Data and Generating an Electronic Representation of Vehicle Operations;”

U.S. publication no. 2011-0022433-A1, published Jan. 27, 2011, filed Jun. 24, 2010, and entitled “Methods and Apparatus for Assessing Locate Request Tickets;”

U.S. publication no. 2011-0040589-A1, published Feb. 17, 2011, filed Jul. 21, 2010, and entitled “Methods and Apparatus for Assessing Complexity of Locate Request Tickets;”

U.S. publication no. 2011-0046993-A1, published Feb. 24, 2011, filed Jul. 21, 2010, and entitled “Methods and Apparatus for Assessing Risks Associated with Locate Request Tickets;”

U.S. publication no. 2011-0046994-A1, published Feb. 17, 2011, filed Jul. 21, 2010, and entitled “Methods and Apparatus for Multi-Stage Assessment of Locate Request Tickets;”

U.S. publication no. 2011-0040590-A1, published Feb. 17, 2011, filed Jul. 21, 2010, and entitled “Methods and Apparatus for Improving a Ticket Assessment System;”

U.S. publication no. 2011-0020776-A1, published Jan. 27, 2011, filed Jun. 25, 2010, and entitled “Locating Equipment for and Methods of Simulating Locate Operations for Training and/or Skills Evaluation;”

U.S. publication no. 2010-0285211-A1, published Nov. 11, 2010, filed Apr. 21, 2010, and entitled “Method Of Using Coded Marking Patterns In Underground Facilities Locate Operations;”

U.S. publication no. 2011-0137769-A1, published Jun. 9, 2011, filed Nov. 5, 2010, and entitled “Method Of Using Coded Marking Patterns In Underground Facilities Locate Operations;”

U.S. publication no. 2009-0327024-A1, published Dec. 31, 2009, filed Jun. 26, 2009, and entitled “Methods and Apparatus for Quality Assessment of a Field Service Operation;”

U.S. publication no. 2010-0010862-A1, published Jan. 14, 2010, filed Aug. 7, 2009, and entitled, “Methods and Apparatus for Quality Assessment of a Field Service Operation Based on Geographic Information;”

U.S. publication No. 2010-0010863-A1, published Jan. 14, 2010, filed Aug. 7, 2009, and entitled, “Methods and Apparatus for Quality Assessment of a Field Service Operation Based on Multiple Scoring Categories;”

U.S. publication no. 2010-0010882-A1, published Jan. 14, 2010, filed Aug. 7, 2009, and entitled, “Methods and Apparatus for Quality Assessment of a Field Service Operation Based on Dynamic Assessment Parameters;”

U.S. publication no. 2010-0010883-A1, published Jan. 14, 2010, filed Aug. 7, 2009, and entitled, “Methods and Apparatus for Quality Assessment of a Field Service Operation Based on Multiple Quality Assessment Criteria;”

U.S. publication no. 2011-0007076-A1, published Jan. 13, 2011, filed Jul. 7, 2010, and entitled, “Methods, Apparatus and Systems for Generating Searchable Electronic Records of Underground Facility Locate and/or Marking Operations;”

U.S. publication no. 2012-0019380-A1, published Jan. 26, 2012, filed Jul. 25, 2011, and entitled, “Methods, Apparatus and Systems for Generating Accuracy-annotated Searchable Electronic Records of Underground Facility Locate and/or Marking Operations;

U.S. publication no. 2011-0279229, published Nov. 17, 2011, filed Jul. 25, 2011, and entitled, “Methods, Apparatus and Systems for Generating Location-Corrected Searchable Electronic Records of Underground Facility Locate and/or Marking Operations;”

U.S. publication no. 2011-0279230, published Nov. 17, 2011, filed Jul. 26, 2011, and entitled, “Methods, Apparatus and Systems for Generating Searchable Electronic Records of Underground Facility Locate and/or Marking Operations and Assessing Aspects of Same;”

U.S. publication no. 2011-0279476, published Nov. 17, 2011, filed Jul. 26, 2011, and entitled, “Methods, Apparatus and Systems for Generating Imaged-Processed Searchable Electronic Records of Underground Facility Locate and/or Marking Operations;”

U.S. publication no. 2011-0285749, published Nov. 24, 2011, filed Jul. 29, 2011, and entitled, “Methods, Apparatus and Systems for Generating Digital-Media-Enhanced Searchable Electronic Records of Underground Facility Locate and/or Marking Operations;”

U.S. publication no. 2011-0283217, published Nov. 17, 2011, filed Jul. 29, 2011, and entitled, “Methods, Apparatus and Systems for Generating Searchable Electronic Records of Underground Facility Locate and/or Marking Operations;”

U.S. publication no. 2011-0236588-A1, published Sep. 29, 2011, and entitled, “Methods, Apparatus, and Systems for Facilitating Compliance with Marking Specifications for Dispensing Marking Material;”

U.S. publication no. 2011-0131081-A1, published Jun. 2, 2011, filed Oct. 29, 2010, and entitled “Methods, Apparatus, and Systems for Providing an Enhanced Positive Response in Underground Facility Locate and Marking Operations;”

U.S. publication no. 2011-0060549-A1, published Mar. 10, 2011, filed Aug. 13, 2010, and entitled, “Methods and Apparatus for Assessing Marking Operations Based on Acceleration Information;”

U.S. publication no. 2011-0117272-A1, published May 19, 2011, filed Aug. 19, 2010, and entitled, “Marking Device with Transmitter for Triangulating Location During Locate Operations;”

U.S. publication no. 2011-0045175-A1, published Feb. 24, 2011, filed May 25, 2010, and entitled, “Methods and Marking Devices with Mechanisms for Indicating and/or Detecting Marking Material Color;”

U.S. publication no. 2011-0191058-A1, published Aug. 4, 2011, filed Aug. 11, 2010, and entitled, “Locating Equipment Communicatively Coupled to or Equipped with a Mobile/Portable Device;”

U.S. publication no. 2010-0088135 A1, published Apr. 8, 2010, filed Oct. 1, 2009, and entitled, “Methods and Apparatus for Analyzing Locate and Marking Operations with Respect to Environmental Landmarks;”

U.S. publication no. 2010-0085185 A1, published Apr. 8, 2010, filed Sep. 30, 2009, and entitled, “Methods and Apparatus for Generating Electronic Records of Locate Operations;”

U.S. publication no. 2011-0095885 A9 (Corrected Publication), published Apr. 28, 2011, and entitled, “Methods And Apparatus For Generating Electronic Records Of Locate Operations;”

U.S. publication no. 2010-0090700-A1, published Apr. 15, 2010, filed Oct. 30, 2009, and entitled “Methods and Apparatus for Displaying an Electronic Rendering of a Locate Operation Based on an Electronic Record of Locate Information;”

U.S. publication no. 2010-0085054 A1, published Apr. 8, 2010, filed Sep. 30, 2009, and entitled, “Systems and Methods for Generating Electronic Records of Locate And Marking Operations;”

U.S. publication no. 2012-0036140 A1, published Feb. 9, 2012, filed Aug. 5, 2010, and entitled, “Methods and Apparatus for Analyzing Locate and Marking Operations by Comparing Filtered Locate and/or Marking Information;”

U.S. publication no. 2011-0249394-A1, published Oct. 13, 2011, filed Jan. 31, 2011, and entitled, “Locating Equipment Docking Station Communicatively Coupled To or Equipped with a Mobile/Portable Device;”

U.S. publication no. 2012-0066273-A1, published Mar. 15, 2012, filed Jul. 18, 2011, and entitled, “System for and Methods of Automatically Inserting Symbols into Electronic Records of Locate Operations;”

U.S. publication no. 2012-0066506-A1, published Mar. 15, 2012, filed Jul. 18, 2011, and entitled, “Methods, Apparatus and Systems for Onsite Linking to Locate-Specific Electronic Records of Locate Operations;”

U.S. publication no. 2012-0066137-A1, published Mar. 15, 2012, filed Jul. 19, 2011, and entitled, “System For and Methods of Confirming Locate Operation Work Orders with Respect to Municipal Permits;”

U.S. publication no. 2012-0065924-A1, published Mar. 15, 2012, filed Aug. 15, 2011, and entitled, “Methods, Apparatus and Systems for Surface Type Detection in Connection with Locate and Marking Operations;”

U.S. publication no. 2012-0069178-A1, published Mar. 22, 2012, filed Sep. 19, 2011, and entitled, “Methods and Apparatus for Tracking Motion and/or Orientation of a Marking Device;”

U.S. publication no. 2012-0065944-A1, published Mar. 15, 2012, filed Aug. 11, 2011, and entitled, “Methods, Apparatus and Systems for Facilitating Generation and Assessment of Engineering Plans;” and

U.S. publication no. 2012-0072035-A1, published Mar. 22, 2012, filed Sep. 14, 2011, and entitled, “Methods and Apparatus for Dispensing Material and Electronically Tracking Same.”

U.S. publication no. 2011-0046999-A1, published Feb. 24, 2011, filed Aug. 4, 2010, and entitled, “Methods and Apparatus for Analyzing Locate and Marking Operations by Comparing Locate Information and Marking Information.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1A is a functional block diagram of an activity tracking system in accordance with an embodiment of the present invention.

FIG. 1B is a functional block diagram of an example of a computer for collecting information used for chronicling the activities of field technicians, according to embodiments of the invention.

FIG. 1C is a functional block diagram of a central server including a workforce management application for processing and assigning operation work orders to one or more field technicians, according to embodiments of the invention.

FIG. 2 is a functional block diagram of examples of data sources that may be used for chronicling the activities of field technicians, according to embodiments of the invention.

FIG. 3 illustrates examples of systems that may serve as data sources of the activity tracking system, according to embodiments of the invention.

FIG. 4 illustrates examples of computer applications that may serve as data sources of the activity tracking system, according to embodiments of the invention.

FIG. 5 illustrates examples of sources that may serve as data sources of the activity tracking system, according to embodiments of the invention.

FIG. 6 illustrates examples of sensors that may serve as data sources of the activity tracking system, according to embodiments of the invention.

FIG. 7 illustrates examples of devices that may serve as data sources of the activity tracking system, according to embodiments of the invention.

FIG. 8 illustrates examples of timelines of data streams of the data sources of the activity tracking system, according to embodiments of the invention.

FIG. 9 is a flow diagram of a method of collecting and processing data streams for chronicling the activities of field technicians, according to embodiments of the invention.

FIG. 10 illustrates a flow diagram of an example of a method of operation of the activity tracking system, according to one embodiment of the invention.

FIG. 11 illustrates an example of a clock in menu of the activity tracking system, according one embodiment of the invention.

FIG. 12 illustrates an example of a time entry manifest that is preserved for each clock event of the activity tracking system, according to one embodiment of the invention.

FIG. 13 illustrates an example of an explanation dialog box of the activity tracking system, according to one embodiment of the invention.

FIG. 14 illustrates an example of a clock out menu of the activity tracking system, according to one embodiment of the invention.

FIG. 15 illustrates an example of an end of day timesheet of the activity tracking system, according to one embodiment of the invention.

### DETAILED DESCRIPTION

Following below are detailed descriptions of various concepts related to, and embodiments of, inventive methods, apparatus and systems for tracking the activities of field technicians. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

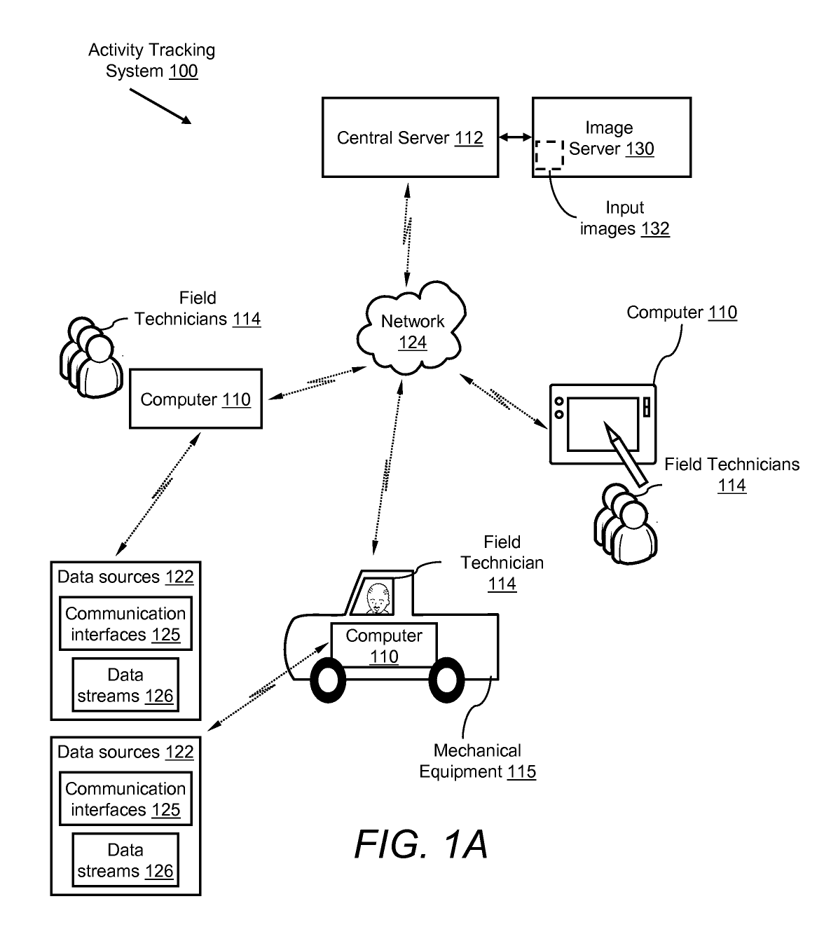

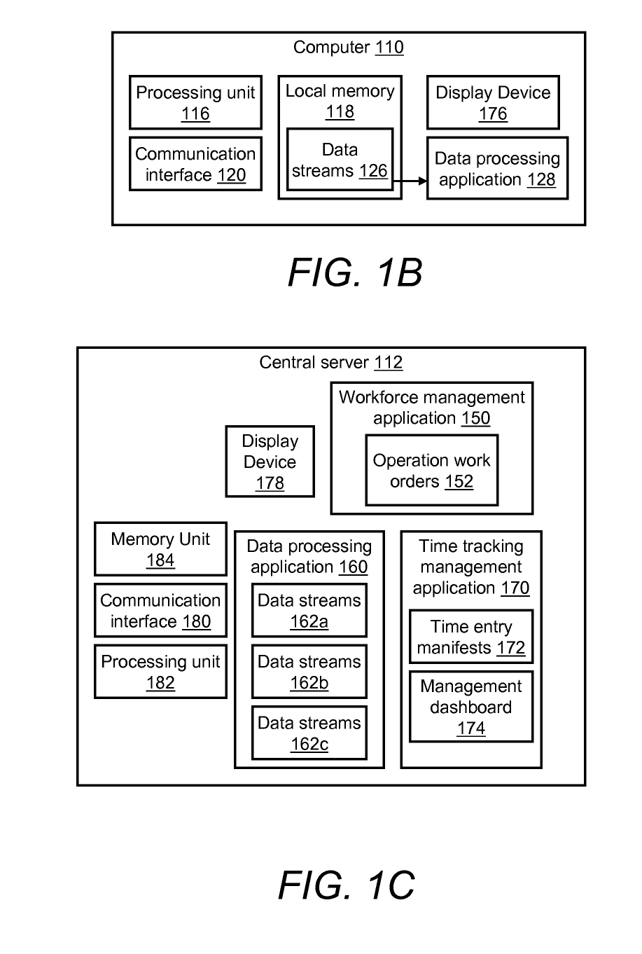

FIG. 1A illustrates an activity tracking system 100 for monitoring the daily activities of field technicians 114, according to one embodiment of the present invention. A field technician 114, for example, generally includes a user of tracking system 100 who can perform on site service (e.g., a service technician) or location operations (e.g. a locate technician) at or near the location of a job site. The activity tracking system 100 may include one or more computers 110 configured to execute computer applications to process data associated with the activities of various classes of users. For example, a computer 110 may be configured to provide functions and interfaces configured for field technicians. Other exemplary computers may be configured to provide interfaces for crew foremen, supervisors, field office clerks, office supervisors, or other employees who manage, view, access, or audit information processed by activity tracking system 100. Computers 110 also may be configured to communicate with a central server 112 via communications network 124 to transmit and receive data. Computers 110 may be operatively connected to an image server 130 via network 124 and central server 112. Activity tracking system 100 and associated computers 110 also may be configured to communicate with one or more data sources 122. In an embodiment, computer 110 is geo-enabled. For example, computer 110 may obtain geographic location information from a local storage unit. In another example, computer 110 may be operatively coupled to a location tracking system of central server 112 or image server 130 to obtain geographic or other location related information such as latitude or longitude coordinates. In another embodiment, mechanical equipment 115, such as vehicles, used by technicians or other personnel in the field may be equipped with onboard computers 110 that are capable of collecting digital information from equipment and/or tools that are assigned to, used by, related to, and/or otherwise associated with individual field technicians or other personnel. The mechanical equipment 115 can include automotive vehicles, tractors, plows, or industrial machines, for example. The mechanical equipment can include mobile machines (e.g., vehicles) as well as fixed or stationary machines such as a boring tool machine that can be anchored to the ground, or a ground penetrating radar device equipped with the computer 110. The computer 110 may include a mobile or cellular telephone such as a smart phone that is configured to operate (e.g., using one or more applications) as a data collection or transmission tool. In one embodiment, the computer 110 includes cellular phone used by technicians or other personnel in the field to obtain information about who the technicians (or other personnel) are calling, or the location of the technicians.

In one example, activity monitoring system 100 may be configured to receive from computer 110 data source information from one or more data sources 122 associated with one or more technicians regarding daily work activities, such as checking in/out, job task verification, and location verification via communication interfaces 125. In one aspect, data sources 122 may provide one or more data streams 126 of activity data to computer 110.

Data sources 122 may include, for example, any numbers, any types, and any combinations of systems, computer applications, sources, sensors, and devices that generate respective data streams used for chronicling the activities, locations, or travel routes of field technicians 114 or other users. Person-based and time-oriented records of activity may be compiled from the data streams of any numbers of data sources, any types of data sources, and any combinations of data sources for chronicling the activities of technicians.

In an embodiment of the activity tracking system 100, technician-based records of activities may include imagery that provides contextual information about field-service activities. For example, the activity tracking system 100 may provide input images 132 received from image server 130. The images may be associated with specific geographic coordinates or references, for example to indicate information such as geographic location of each clock-in or clock-out event. The images may also be associated with geographic coordinates to indicate time and location information associated with each job of the day, and/or route information associated with one or more field service personnel during the day. In one embodiment, a time entry manifest can be generated to indicate field service activities that include time and/or location information. The field service activities can include, for example, administrative activities such as the closing of a work order or ticket, technician time tracking system logon or logoff information; cellular phone usage, or technician correspondence with a supervisor, for example to check in with the supervisor or report arrival at a geographic location.

Image server 130 may be any computer device for storing and providing input images 132. An input image 132 may be any image represented by source data that is electronically processed (e.g., the source data is in a computer-readable format) to display the image on a display device. For example, an input image 132 may include any of a variety of paper/tangible image sources that are scanned (e.g., via an electronic scanner) or otherwise converted so as to create source data (e.g., in various formats such as XML, PDF, JPG, BMP, etc.) that can be processed to display the input image 132. In an embodiment, image server 130 may be associated with a party that provides aerial images of geographic locations for a fee. An input image 132 also may include an image that originates as source data or an electronic file without necessarily having a corresponding paper/tangible copy of the image (e.g., an image of a “real-world” scene acquired by a digital still frame or video camera or other image acquisition device, in which the source data, at least in part, represents pixel information from the image acquisition device).

In an embodiment, one or more input images 132 may be created, provided, and/or processed by a geographic information system (GIS) that captures, stores, analyzes, manages and presents data referring to (or linked to) location, such that the source data representing the input image 132 includes pixel information from an image acquisition device (corresponding to an acquired “real world” scene or representation thereof), and/or spatial/geographic information (“geo-encoded information”). A GIS may provide a framework for data manipulation and display of images that may facilitate one or more of (a) location verification, (b) location correlation, (c) locational relationships, (d) district coding, (e) route analysis, (f) area analysis and (g) mapping/display creation, for example.

Examples of input images and source data representing input images 132 may include but are not limited to:

Manual “free-hand” paper sketches of the geographic area (which may include one or more buildings, natural or man-made landmarks, property boundaries, streets/intersections, public works or facilities such as street lighting, signage, fire hydrants, mail boxes, parking meters, etc.);

Various maps indicating surface features and/or extents of geographical areas, such as street/road maps, topographical maps, military maps, parcel maps, tax maps, town and county planning maps, call-center and/or facility polygon maps, virtual maps, etc. (such maps may or may not include geo-encoded information);

Architectural, construction and/or engineering drawings and virtual renditions of a space/geographic area (including “as built” or post-construction drawings);

Land surveys, i.e., plots produced at ground level using references to known points such as the center line of a street to plot the metes and bounds and related location data regarding a building, parcel, utility, roadway, or other object or installation;

A grid (a pattern of horizontal and vertical lines used as a reference) to provide representational geographic information (which may be used “as is” for an input image 132 or as an overlay for an acquired “real world” scene, drawing, map, etc.);

“Bare” data representing geo-encoded information (geographical data points) and not necessarily derived from an acquired/captured real-world scene (e.g., not pixel information from a digital camera or other digital image acquisition device). Such “bare” data may be nonetheless used to construct a displayed input image 132, and may be in any of a variety of computer-readable formats, including XML; and

Photographic renderings/images, including street level, topographical, satellite, and aerial photographic renderings/images, any of which may be updated periodically to capture changes in a given geographic area over time (e.g., seasonal changes such as foliage density, which may variably impact the ability to see some aspects of the image).

One of ordinary skill in the art would appreciate that source data associated with an input image 132 may be compiled from multiple data/information sources. For example, two or more of the exemplary image data types provided above for input images and source data representing input images 132, or any two or more other data sources, may be combined in whole or in part or may be integrated to form source data that is electronically processed to display an image on a display device.

Computers 110, central server 112, and image server 130 all have network communication capability and are able to exchange information via a network 124. Network 124 may be, for example, any local area network (LAN) and/or wide area network (WAN) for connecting to the Internet. Additionally, the connection of portable computers 110, central server 112, and image server 130 to network 124 may be by any wired and/or wireless means.

According to an embodiment, computer 110 is geo-enabled, which allows activity tracking system 100 to be used for tying timekeeping activity to real-time geo-location information. For example activity tracking system 100 may be configured to indicate various information on input images 132, such as, (1) the time and geographic location of each clock in and clock out event of the day by field technicians 114 and (2) the time and geographic location of each field service job site of the day. Additionally, at the end of the day, all or part of the route taken by field technicians 114 for the day may be indicated on input images 132 and stored electronically, thereby creating an electronic time entry manifest of field service activities. The tracking system 100 may be configured to indicate, track, and/or store planned routs (e.g., for the technician) and taken routes (e.g., by the technician). Additionally, based on field service work orders that are assigned to field technicians 114, activity tracking system 100 may be used for correlating and/or monitoring actual field service activity with respect to expected field service activity. In an embodiment, activity tracking system 100 may be used for prompting field technicians 114 to confirm activities performed and/or provide input regarding discrepancies between actual field service activity and expected field service activity.

In another embodiment, activity tracking system 100 may generate one or more message alerts based at least in part on one or more triggering activities. For example, activity tracking system 100 may be configured to generate an email alert for certain trigger activities, such as, but not limited to, the field technician 114 or other user has not clocked in by certain time, the user has not moved in one hour, and the user has not taken lunch by a certain time. In another embodiment, an audit log may be maintained to track message alerts that are sent by activity tracking system 100 along with information associated with the triggering event. The message alerts can be sent by the activity tracking system 100 to one or more field technician, supervisor, person at a job site, owner of the land at the job site, customer, or excavator.

As shown in FIG. 1A, computer 110 may be operatively coupled to one or more data sources 122 associated with the computer 110 and field technician 114. Data sources 122 may provide information regarding the chronological activities performed by field technician 114. For example, data source 122 may be a tool configured to provide information regarding location information, time of use, and other information associated with the technician's work that involves using the tool. Computer 110 may receive such information and may generate a work input that identifies and categorizes the received information.

FIG. 1B illustrates an exemplary computer 110 including a processing unit 116, a local memory 118, a communication interface 120, and a display device 176. Computer 110 may be any computing device assigned to and configured to be used by field technician 114. For example, computer may be a notebook computer, tablet, mobile phone, in-vehicle computer, or any other device configured to display and receive data for use by field technician 114.

Processing unit 116 of computer 110 may be any standard controller or microprocessor device that is capable of executing program instructions. Local memory 118 may be any data storage mechanism for storing information that is processed locally at computer 110. In one embodiment, local memory 118 may be any combination of Random Access Memory (RAM) or Read-Only Memory (ROM) configured to store information associated with the activities of field technician 114. The display device 176 can be a standard display such as a computer monitor or graphical user interface.

Computer 110 may be configured to include one or more communication interfaces 120 for connecting to a wired or wireless network by which information (e.g., the contents of local memory 118) may be exchanged with other devices connected to the network. Examples of wired communication interfaces may include, but are not limited to, universal serial bus (USB) ports, RS232 connectors, RJ45 connectors, Ethernet, and any combinations thereof. Examples of wireless communication interfaces may include, but are not limited to, an Intranet connection, Internet, Bluetooth® technology, Wi-Fi, Wi-Max, IEEE 802.11 technology, radio frequency (RF), Infrared Data Association (IrDA) compatible protocols, Local Area Networks (LAN), Wide Area Networks (WAN), Shared Wireless Access Protocol (SWAP), any combinations thereof, and other types of wireless networking protocols.

Data sources 122, such as a mobile phone, personal display assistant, smart phone, tablet, or mobile device, are configured to communicate with computer 110 via one or more communication interfaces 120. In one example, the information from data sources 122 may be in the form of respective data streams 126 that may be transmitted to computer 110 and stored in local memory 118. Data streams 126, other information from data sources 122, input images 132, or other information such as work orders can be provided to the display device 176 of the computer 110 for display. For example a work order assigned to a field technician 114 can be provided from the local memory 118 of the computer 110 to the display device 176 for display to the field technician 114. In another example, information from data sources 122 may be aggregated according to the field technician 114 associated with the data sources 122.

Computer 110 may also be configured to execute a data processing application 128 for processing the contents of data streams 126 received from data sources 122 with respect to chronicling the activities of field technicians, for example at a job site. In one example, data processing application 128 may correlate with respect to time any data stream 126 with one or more other data streams 126. The output of data processing application 128 may be, for example, one or more daylong timelines of the activities of a particular field technician 114. The timelines can be stored in the local memory 118. In one embodiment, the computer 110 provides the timelines for display at the display device 176.

Referring to FIG. 1C, central server 112 may be configured to include a workforce management application 150 for processing and assigning operation work orders 152 to, for example, one or more technicians 114 that are dispatched into the field. Work orders 152 may be displayed to the field technicians 114 at the display device 176 of the computer 110. Operation work orders 152 may be any work orders for services that are submitted to a service company. Information related to such work orders may be imported from or exported to other systems (not shown) using techniques, such as eXtensible Markup Language (XML) schema definitions, configured to facilitate information processing by central server 112. For example, an XML schema for work orders may include fields relating to the type of work to be performed, the work units available for the field technician 114, and any other data related to the work or work entry. In one embodiment, each field technician 114 may receive and process one or more work orders 152 in the span of a day via computer 110 associated with field technician 114. Consequently, in this example in any given day each field technician 114 performs work according to the information of the one or more work orders 152. In one embodiment, operation work orders 152 may relate to locate operations for field technicians 114.

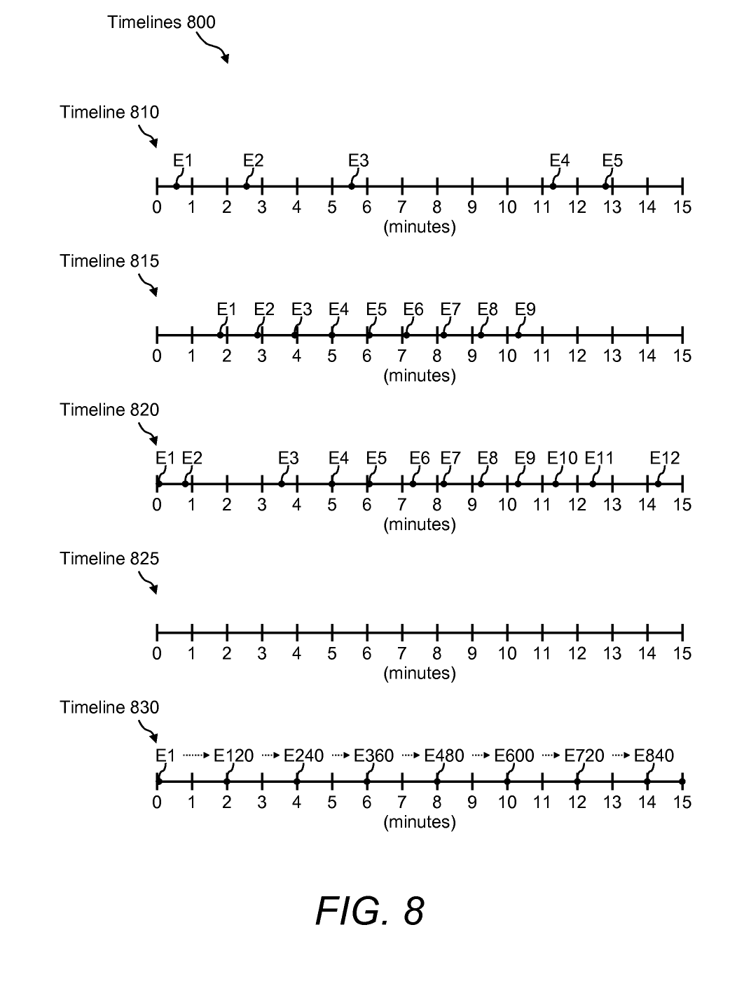

Additionally, data processing application 160 may be installed at central server 112. Data processing application 160 may be used for compiling one or more data streams 126 associated with each field technician 114 for a specified time period. Data processing application 160 may also be used for analyzing the respective data streams 126 to generate, for example, one or more timelines, such as timelines 800 of FIG. 8, which may be used for chronicling the activities of field technicians 114 or other users in the field, as will be discussed below in further detail. In another example, data processing application 160 may be used for analyzing one or more data streams 162a, 162b, and 162c, which correspond to respective data streams of field technicians 114. In one embodiment, data streams 126 and data streams 162a-c include the same information about activities of at least user, e.g., a field technician 114 carrying out a work order (e.g., ticket) at a job site. In this example, data streams 126 can be generated at or transmitted from computer 110, and data streams 162a-c can be generated, received by, or transmitted from central server 112. The work order (e.g., ticket) can suggest an order of operations (e.g., a workflow) for the field technician 114 to follow, and the data processing application 160 can analyze one or more data streams 162a, 162b, or 162c to determine whether or not the order of operations was followed in the correct order. The data processing application 160 can transmit messages or alerts indicated that the order of operations was, or was not followed. The workflow or order of operations can be provided as a series of discrete steps, or as a tree structure. For example, the work order can indicate an order in which the field technician 114 is to locate gas, water, and electrical utilities.

In one embodiment, the central server 112 includes a display device 178 such as a computer monitor. For example, the processing unit 182 of the central server 112 can provide one or more input images 132, work orders 152 or data streams 162a-c to the display device 178 via the communication interface 180, for display at the display device 178. In another example the timelines are displayed at the display device 178 of the central server 112. The central server 112 can also include at least one memory unit 184 to store any of the input images 132, work orders 152, data streams 162a-c, or timelines. The memory unit 184 can also store the data processing application 160, the time tracking management application 170, and the workforce management application 150.

In some embodiments, the communication interface 180 of the central server 112 communicates information (e.g., work orders 152) to the communication interface 120 of the computer 110. For example, the central processing unit 182 of the central server 112 can provide input images 132 and work orders 152 from the memory unit 184 of the central server 112 to the processing unit 116 of the computer 110, where this information can be stored in the local memory 118 of the computer 110. In this example, the field technician 114 can perform field service activity corresponding to a work order 152 and generate data streams 162a-c. These data streams can be received at the communication interface 120 of the computer 110, stored in the local memory 118, associated with time and location information, and provided to the central server 112 via the network 124 e.g., in the form of a timeline.

In an embodiment, and with reference to FIGS. 1-4, a time tracking and management application 170 may also be installed on central server 112 and may be configured to communicate with a time tracking client application 430 configured to execute on one or more client devices, such as computer 110. In one example, time tracking and management application 170 may be configured to tie timekeeping activity to real-time geo-location and/or geo-tracking information by tying geo-location data from location tracking system 314 of computers 110 (e.g., a smart phone) to clock-in and clock-out events, as well as to any other events of interest. A management dashboard 174 associated with time tracking and management application 170 may be provided that allows one or more users (e.g., a supervisor) to manage information provided to application 170, including determining daily or current status information and production performance of individual field technicians 114. In one embodiment, status tracking is available in as near “real time” as possible given existing limitations of network connections and datacenter synchronization delays. For example, management dashboard 174 may be configured to allow one or more supervisors to determine whether an individual field technician 114 is working on the clock, is on break, or is off duty and may review the clock events and shift time of each field technician 114 in relation to one or more work orders 152.

In one embodiment, management dashboard 174 is provided by central server 112 as a management dashboard application that is separate from time tracking client application 430 at each portable computer 110. In one example, management dashboard 174 may provide relevant user performance data by supervisor and service date.

In another embodiment, management dashboard 174 allows users to review information related to field technicians 114 and related work orders 152, such as clock in/out activities, number of work orders 152 processed, GPS data associated with arrivals and departures, on-site time, travel time, travel miles, call outs, or any other data associated with technicians' activities or work orders. In an embodiment, management dashboard 174 entries may be configured to identify different types of conditions that have occurred, which may require review by a supervisor. For example, conditions may be color-coded to identify the first clock in location was not at the first work order 152 of the day, the lunch clock out location was not at a work order 152 location, the lunch clock in is at the next work order 152, the field technician 114 selected that the system-generated location was not accurate, the field technician 114 clocked out for a personal appointment, different expected versus actual start time, not enough time taken for lunch, and no clock out for lunch. The conditions can also indicate the time taken to perform an operation or execute a task. The management dashboard 174 can also allow users to review information related to field technicians 114 and related work orders 152, such as quality scores related to work performed, or how well field technician 114 followed instructions. For example, a color code quality assessment (or other visual display) can indicate the quality of an operation performed by field technician 114. The management dashboard 174 can also indicate a risk assessment or level of risk (e.g., a risk score) corresponding to an operation at a job site. The management dashboard 174 can allow users to review the color code quality assessment concurrently with the risk assessment e.g., as an overlay on a display. The overlay can indicate points of interest such as nearby facilities (e.g., a hospital or a school) that may increase the risk assessment. For example, a well done job may nevertheless have a higher risk assessment if it is done near a hospital, or in a high density urban area, where the potential for additional underground utilities or civilian bystanders is increased. It is to be understood that these examples of possible conditions and methods of identifying such conditions are merely exemplary and are not intended to be limiting.

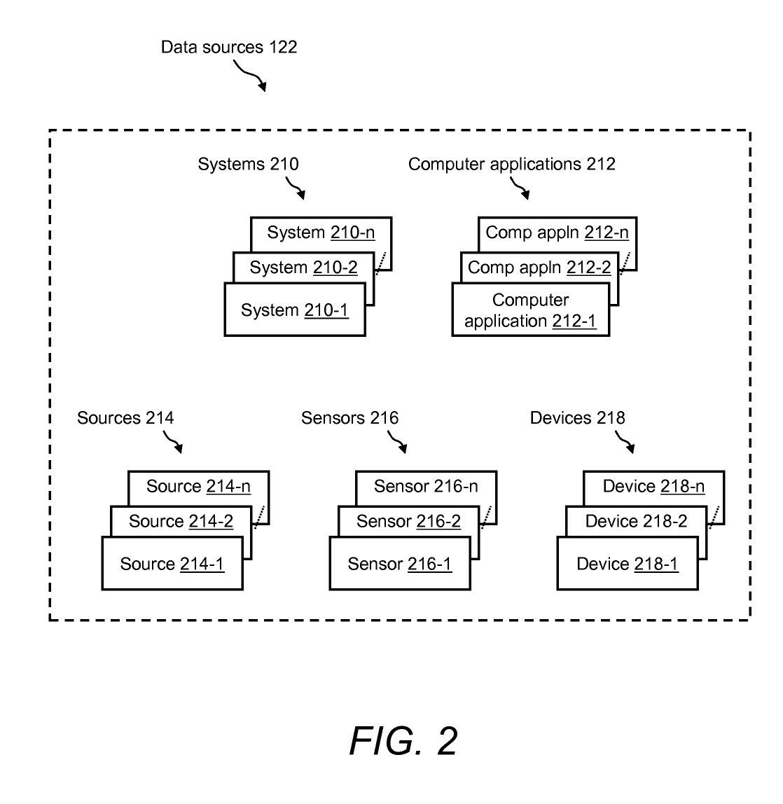

FIG. 2 illustrates examples of data sources 122 that may be used for chronicling the activities of field technicians 114, according to various embodiments of the invention. Data sources 122 may be, but are not limited to, any numbers, any types, and any combinations of systems 210 (e.g., systems 210-1 through 210-n), computer applications 212 (e.g., computer applications 212-1 through 212-n), sources 214 (e.g., sources 214-1 through 214-n), sensors 216 (e.g., sensors 216-1 through 216-n), and devices 218 (e.g., devices 218-1 through 218-n. In some embodiments, combinations of systems 210, computer applications 212, sources 214, sensors 216, and devices 218 may be installed on, configured to run on, or operatively coupled to one or more computers 110 associated with field technicians 114.

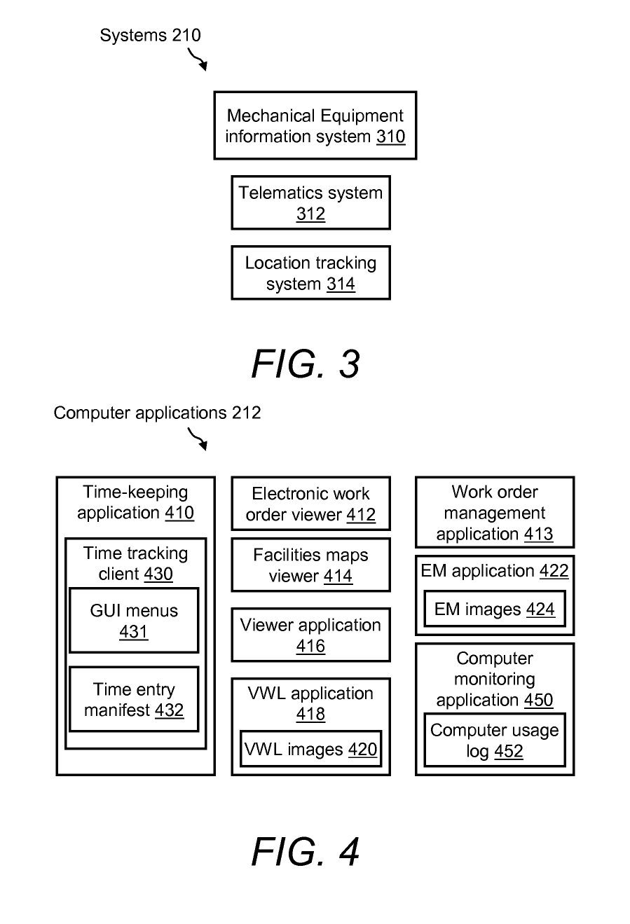

FIG. 3 provides examples of systems 210 that may be capable of providing useful information with respect to chronicling the activities of field technicians 114. Systems 210 may include, but are not limited to, a mechanical equipment (e.g., vehicle) information system (MEIS) 310, a telematics system 312, a location tracking system 314, or other systems configured to provide location and activity information.

MEIS 310 may be any system found in as the mechanical equipment 115 (e.g., a vehicle). In one example, MEIS 310 may be an onboard diagnostic system, such as the OBD-II onboard diagnostic system. In one embodiment, an onboard diagnostic system provides an electronic means to control engine functions, diagnose engine problems, monitor parts of the chassis, body, and accessory devices, and interact with other features of the vehicle or other mechanical equipment.

Telematics system 312 refers to the integrated use of telecommunications and informatics. In one example, telematics have been applied specifically to the use of Global Positioning System (GPS) technology that is integrated with one or more computers and mobile communications technology, such as mobile devices or automotive navigation technologies. One example of telematics system 312 is a mechanical equipment telematics system that may be present in mechanical equipment 115 associated with field technician 114 and that may provide ongoing location or tracking information.

In an embodiment, location tracking system 314 may include any device that can determine its geographical location to a known degree of accuracy. For example, location tracking system 314 may include a GPS receiver or a global navigation satellite system (GNSS) receiver. A GPS receiver may provide, for example, a standard format data stream, such as a National Marine Electronics Association (NMEA) data stream. In another aspect, location tracking system 314 may also include an error correction component, which may be any mechanism for improving the accuracy of the geo-location data.

FIG. 4 provides examples of types of computer applications 212, which also may serve as data sources 122. Computer applications 212 may be computer applications that are capable of providing information with respect to the activities of field technicians 114. Computer applications 212 may be installed, running on, or configured to run on, for example, computer 110 of activity tracking system 100. Examples of types of computer applications 212 may include, but are not limited to, a time-keeping application 410, an electronic work order viewer 412, a work order management application 413, a facilities maps viewer 414, another viewer application 416, a virtual white lines (VWL) application 418 for processing VWL images 420, an electronic manifest (EM) application 422 for processing EM images 424, a computer monitoring application 450 that generates a computer usage log 452, or other applications that may provide information regarding the locations or activities of technicians.

Time-keeping application 410 may be any time-keeping application or client by which technicians (e.g., field technician 114) may clock in and clock out. In one embodiment, time-keeping application 410 may be configured to execute on computer 110 to allow technicians to provide timekeeping inputs and receive timekeeping outputs related to their activities. For example, time-keeping application 410 may provide wage and hour guidelines related to technician activities that allow time-keeping application to automatically generate prompts to technicians in real time with respect to clocking-in and clocking-out based on the guidelines. Real-time prompts by time-keeping application 410 may, in certain embodiments, be delivered in advance of an event, such as a scheduled break, to provide advance notice to the field technician 114. For example, a prompt may be delivered to the field technician 114 a pre-defined time (e.g. 15 minutes, 30 minutes, etc.) before the scheduled break time. In another embodiment, time-keeping application 410 may be configured to determine the appropriate wage and hour guidelines based on geo-location information associated with a computer 110 or other devices associated with the technician. Time-keeping application 410 also may communicate with other devices used by technicians, such that technicians may only perform work using the devices when clocked in. Time-keeping application 410 may also disable applications on computer 110. For example, during a scheduled break time, time keeping application can temporarily disable any of computer applications 212 so that field technician 114 does not work during a scheduled break time. In another aspect, time-keeping information may be transmitted by time-keeping application associated with computer 110 to a central server 112 configured to store time-keeping data. In another aspect, time-keeping application 410 may be configured to output employee time record information. Time-keeping application 410 could be locally stored or executed (e.g., at computer 110), or stored or executed at central server 112. In some embodiments, time keeping application 410 is stored or executed via a cloud computing device connected with network 124. In this example, time keeping operations track field technician 114 activities without requiring direct time keeping input by the field technician (e.g., field technician 114 can be unaware that his or her time is being tracked).

Time-keeping application 410 also may be configured to include a time tracking client application 430 configured to process and receive image data associated with activities of field technician 114. For example, time tracking client application 430 may be configured to retrieve image data associated with a particular location of the field technician 114 and/or the computer 110 at a designated time when the technician clocks in for work or changes a status indicator associated with a work order from pending to complete. As such, time tracking client application 430 may provide additional contextual information associated with the activities and locations of field technician 114 throughout a work day. Time tracking client application 430 also may be configured to allow time-keeping application 410 to verify that field technician 114 is at the correct work location by comparing received geo-location information with expected geo-location information. In the event of a mismatch, which would correspond to the field technician 114 being at the wrong job site, time-keeping application 410 may generate a real-time prompt informing the field technician 114 of the situation.

In an embodiment, upon starting the operating system of computers 110, work order data, such as a work order 152 received from central server 112, may be displayed to the field technician 114 or other user by computer 110. Upon arrival at the job site associated with work order 152, time tracking client application 430 may be configured to allow the field technician 114 to clock in and store a current location using geo-location data of location tracking system 314. According to one aspect, a GUI menu 431 may be configured to present the field technician's 114 current geo-location on an aerial image (i.e., one of input images 132 from image server 130) and may provide an icon that denotes the field technician's 114 current location.

Field technicians 114 may travel between job sites throughout the workday, and activity tracking system 100 may be configured to log data associated with their locations based on real-time geo-location information. For example, time tracking client application 430 may log an arrival time and a departure time associated with a specific work order 152 and may generate route information based on the route taken by the field technician 114 to travel to another job site associated with another work order. In embodiments, one or more icons on an aerial image may denote the field technician's 114 presence at each job site. The field technician 114 may clock out and clock in, as desired, using time tracking client application 430. In an embodiment, when computer 110 is shutdown, for example, at the end of the day, the field technician 114 may be given the option to clock out. A time entry manifest 432 of the day's activity is generated that shows the entire route and clock in and clock out activity of an individual field technician 114. In one embodiment, the time entry manifest 432 associated with a field technician 114 may be transmitted to central server 112 and processed by time tracking management application 170. In one example, updates to a time entry manifest 432 processed throughout the day may be transmitted in real time to central server 112.

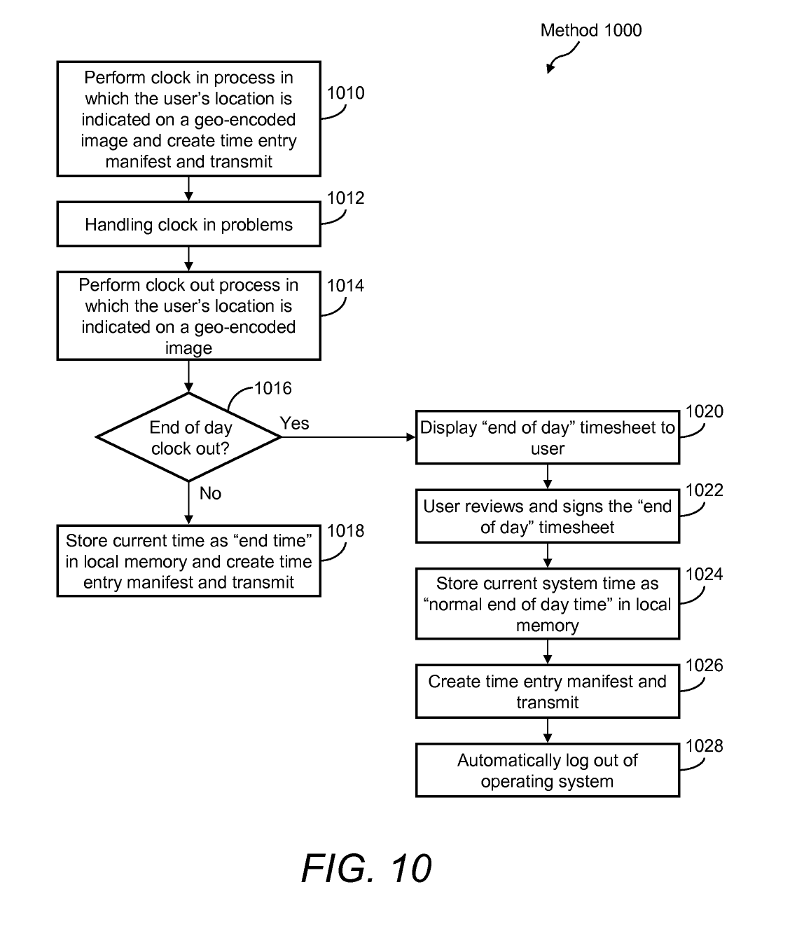

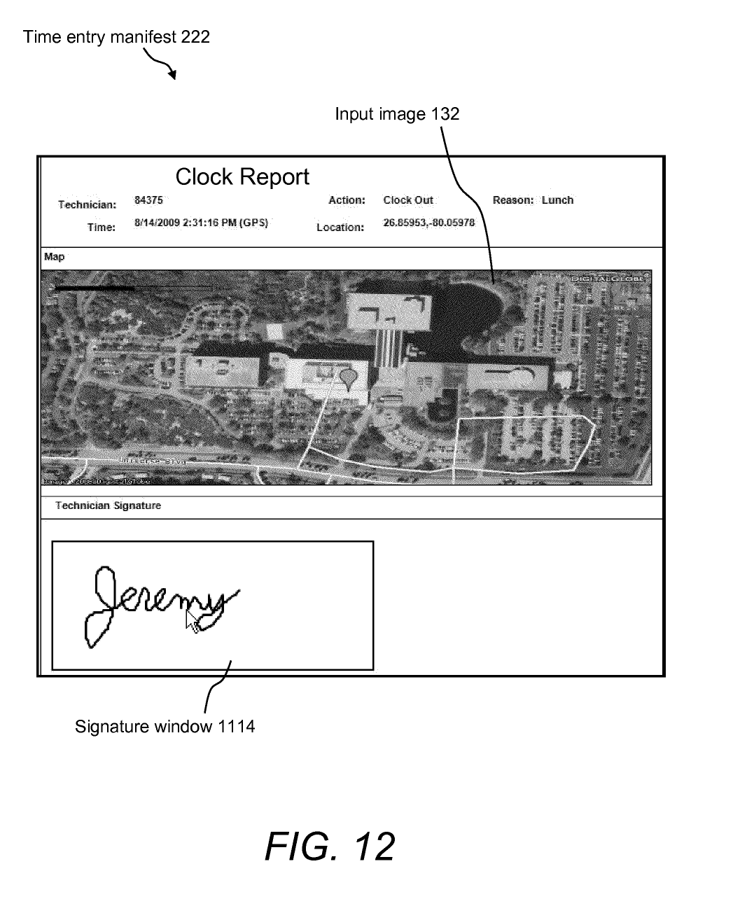

Graphical user interface (GUI) menus 431 may be associated with time tracking client application 430. Examples of GUI menus 431 are shown with reference to FIGS. 10 through 15. Further, the information processed by time tracking client application 430 may be stored as time entry manifests 432. Time entry manifests 432 may be stored in local memory of computer 110. Additional details regarding a time entry manifest 432 generated based on clock events of activity tracking system 100 are described below with reference to FIG. 12.

Electronic work order viewer 412 may be any viewer application that is capable of reading, rendering, and displaying electronic on site (e.g., locate) operation work orders or other information included in data stream 126 or data streams 162a-c, such as time keeping information. With respect to locate operations, electronic locate operation work orders may be the locate operation work orders that are transmitted in electronic form to the field technicians 114. In one aspect, electronic work order viewer 412 may be installed and running on computer 110. In another aspect, work order management application 413 may be installed on computer 110 along with electronic work order viewer 412 to process work orders received by technicians from a dispatch system, including the process of opening and closing locate operation work orders.

Facilities maps viewer 414 may be any viewer application configured to read, render, or display geo-referenced electronic data. In one aspect, facilities maps viewer 414 may be installed on computer 110 and may be configured to display electronic facilities maps that are used by field technicians. In one aspect, electronic facilities maps associated with facilities maps viewer 414 may be electronic records of facilities maps, including physical, electronic, or other representation of the geographic location, type, number, and/or other attributes of a facility or facilities. The geo-referenced electronic facilities maps may be provided in any number of computer file formats.

In one embodiment, viewer application 416 may be installed on computer 110 to display text or graphical information. Viewer application 416 may be any other text and/or graphics viewer application that is capable of reading, rendering, and displaying any other graphics and/or information that may be useful in activity tracking system 100.

In an embodiment, Virtual White Lines (VWL) application 418 may be provided for processing VWL images 420. Textual descriptions of dig areas in which technicians may operate can be very imprecise as to exact physical locations. Therefore, when a locate operation work order is submitted by an excavator, it may be beneficial for the excavator to supplement the locate request with a visit to the site of the dig area for the purpose of indicating the particular geographic location of the proposed excavation. For example, marks may be used to physically indicate a dig area to communicate to a field technician 114 the extent of the boundaries where a locate operation is to be performed. These marks may consist of chalk or paint that is applied to the surface of the ground, and are generally known as “white lines.” VWL application 418 of data sources 122 is a computer software application that provides an electronic drawing tool that may be used by excavators for electronically marking up, for example, a digital aerial image of the dig area, thereby eliminating the need to physically visit the site of the dig area and mark white lines. In one embodiment, the marked-up digital images may be saved as, for example, VWL images 420, which may be associated with one or more operation work orders that are transmitted to the one or more technicians.

In an embodiment, VWL application 418 is installed and running on computer 110. VWL application 418 may be based on, for example, the VWL application that is described with reference to U.S. Patent Publication No. 2009/0238417, entitled “Virtual white lines for indicating planned excavation sites on electronic images;” which is incorporated herein by reference in its entirety.

In another embodiment, technicians may use an EM application 422 to electronically mark up a digital image to indicate the locations where physical work activities were performed. For example, if a technician is involved in a locate operation, the technician may capture a digital image of the location where the locate operation was performed and may electronically mark up the digital image to identify the locations where locate marks were provided. For example, field technician 114 may mark up a digital aerial image of the dig area for indicating locate marks that have been dispensed at the site, thereby indicating the geo-locations and types of facilities present. The starting images to be marked up using EM application 422 may be VWL images 420 that are associated with locate operation work orders. The marked-up digital images may be saved as, for example, EM images 424, which may be associated with locate operation work orders and may be used to support proof of work compliance. In another aspect, a captured digital image may provide evidence of the physical locate marks placed at the job site by identifying and providing a depiction of the actual location where the work was performed.

In one embodiment, the EM application is described with reference to U.S. Patent Application No. 2009/0202110, entitled “Electronic manifest of underground facility locate marks,” which is incorporated herein by reference in its entirety.

Computer monitoring application 450 may be any computer monitoring software for recording activity on a computer. In one embodiment, computer monitoring application 450 is configured to track or record all computer usage and activity record, such as, but not limited to, the usage of computer applications, email, chat rooms, websites visited, and instant messages. Computer monitoring application 450 may be designed for invisible and undetectable monitoring of the computer user's activity. One example of computer monitoring software is the PC Activity Monitor™ (PC Acme™) products described at webpage: http://www.pcacme.com for tracking computer usage and activity.

In one aspect, computer monitoring application 450 may be installed on computer 110 and may be used to monitor the activities of time-keeping application 410, electronic work order viewer 412, facilities maps viewer 414, viewer application 416, VWL application 418, and EM application 422 operating on computer 110. Records associated with computer usage may be stored in at least one usage log, such as computer usage log 452, configured to supply the content of data stream 126 associated with computer monitoring application 450.

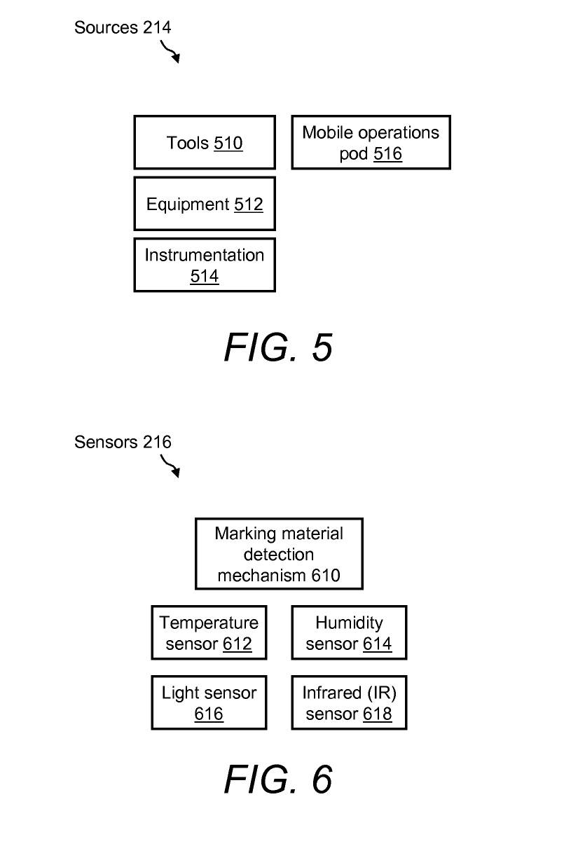

FIG. 5 illustrates examples of types of sources 214. In an embodiment, sources 214, which are yet another example of data sources 122 of activity tracking system 100, may be any sources or devices that are capable of providing information with respect to chronicling the activities of field technicians 114. Examples of types of sources 214 may include, but are not limited to, tools 510, equipment 512, instrumentation 514, a mobile operations pod 516, and the like.

Tools 510, equipment 512, and instrumentation 514 may be any electronically-enabled tools, equipment, and instrumentation, respectively, that may be used by field technicians 114 and that may provide useful information with respect to chronicling the activities of field technicians or other users in the field. Examples of tools, equipment, and instrumentation may include, but are not limited to, power tools, meters, testing equipment, safety equipment (e.g., cones, signs, etc), and other forms of equipment related to the activities of field technicians.

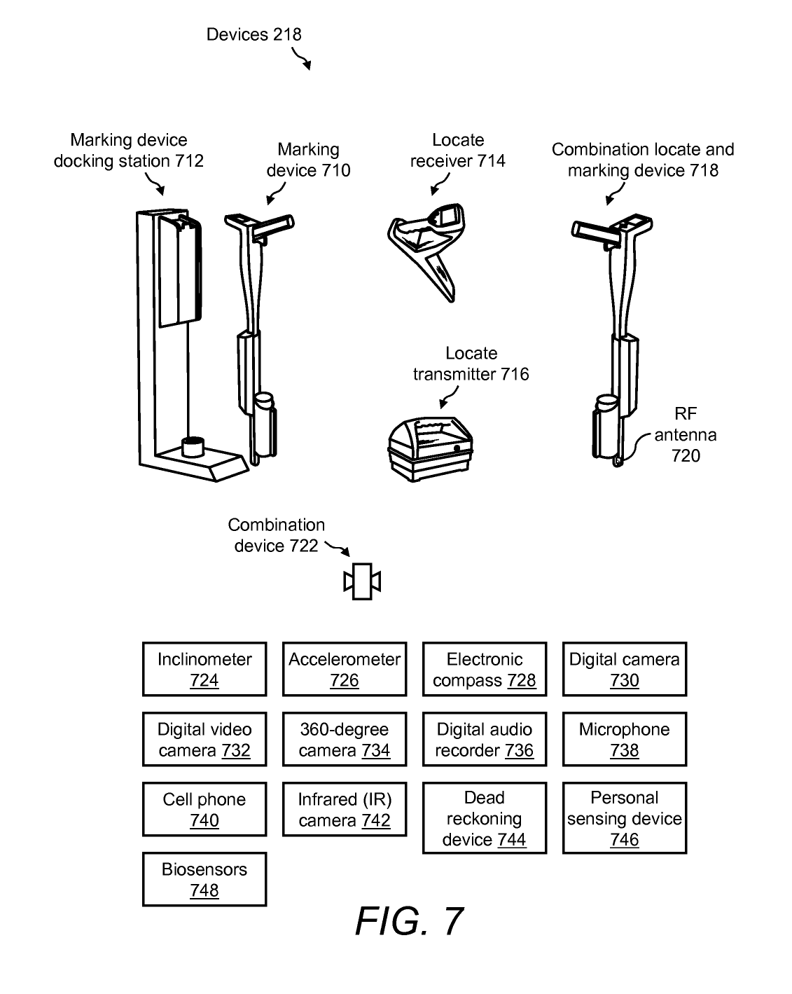

According to one aspect, a mobile operations pod 516 may be used at the job site to support on site operations such as location operations. For example, a mobile operations pod 516 may be a mobile unit configured to communicate with one or more pieces of equipment used by technicians (e.g., one or more electronically-enabled marking devices 710 of FIG. 7, electronically-enabled locate receivers 714 of FIG. 7, and/or electronically-enabled locate transmitters 716 of FIG. 7) at the job site. In one embodiment, the mobile operations pod 516 may be used as a local data collection and processing hub for locating equipment used by the technicians. In another embodiment, the mobile operations pod 516 may be used as a docking station and/or battery recharging station for the locating equipment.

FIG. 6 depicts examples of types of sensors 216. According to an embodiment, sensors 216, which are yet another example of data sources 122 of activity tracking system 100, may be any sensors that are capable of providing useful information with respect to chronicling the activities of field technicians 114 at a job site or between job sites. For example, sensors 216 may include, but are not limited to, a marking material detection mechanism 610, a temperature sensor 612, a humidity sensor 614, a light sensor 616, an infrared (IR) sensor 618, or other sensors related to tasks performed by one or more technicians working in the field. Examples of marking materials may include, but are not limited to, paint, chalk, dye, and/or iron. Marking devices, such as the marking device shown in FIG. 7, are devices for dispensing marking materials onto surfaces.

In one aspect, marking devices may include a marking material detection mechanism, such as marking material detection mechanism 610. Marking material detection mechanism 610 may be any mechanism for determining attributes of the marking material that is being dispensed by the marking device. For example, marking material detection mechanism 610 may include radio-frequency identification (RFID) technology for reading information of an RFID tag that is provided on the marking material dispenser. The marking material dispenser may be an RFID-enabled dispenser that is described with reference to several of the applications incorporated herein by reference. In another example, marking material detection mechanism 610 may be any of the marking material detection mechanisms that are described in U.S. Patent Application No. 2010/0006667, entitled “Marker Detection Mechanism for use in Marking Devices and Methods of Using Same,” which is incorporated herein by reference in its entirety.

Temperature sensor 612, humidity sensor 614, and light sensor 616 are examples of environmental sensors. In one example, temperature sensor 612 may operate from about −40 C to about +125 C. In one example, humidity sensor 614 may provide the relative humidity measurement (e.g., 0% to 100% humidity). In another example, light sensor 616 may be a cadmium sulfide (CdS) photocell, which is a photoresistor device whose resistance decreases with increasing incident light intensity. In this example, the data that is returned from light sensor 168 is a resistance measurement. IR sensor 618 may be an electronic device that measures infrared light radiating from objects in its field of view. IR sensors are used, for example, in proximity detectors and motion detectors.

FIG. 7 illustrates additional examples of types of devices 218, which are still another example of data sources 122 of activity tracking system 100, that may be any devices that are capable of providing useful information with respect to chronicling the activities of field technicians 114. Examples of types of devices 218 may include, but are not limited to, an electronic marking device 710 and its corresponding marking device docking station 712, a locate receiver 714, a locate transmitter 716, a combination locate and marking device 718 which includes a radio-frequency (RF) antenna 720, a combination device 722, an inclinometer 724, an accelerometer 726, an electronic compass 728, a digital camera 730, a digital video camera 732, a 360-degree camera 734, a digital audio recorder 736, a microphone 738, a cell phone 740, an IR camera 742, a dead reckoning device 744, a personal sensing device 746, one or more types of biosensors 748, or other devices configured to provide information regarding the activities of technicians. In one embodiment, cell phone 740 is a work-issued cell phone. Cell phone records can be analyzed. For example, a supervisor can infer information about the activity of field technician 114, e.g., that field technician 114 is present at a job site, present at a job site and not presently clocked-in, or present at a job site, clocked-in, and making non-work related telephone calls, for example. In another example, activity tracking system 100 can track work related telephone calls. For example, the activity tracking system 100 can identify calls from the field technician 114 to supervisors during a time period in which the field technician 114 is not clocked in. In this example the field technician 114 may be improperly working during a scheduled break time, for example,

In one example, the locating equipment may include marking device 710, locate receiver 714, locate transmitter 716, and combinations thereof. Marking devices, such as marking device 710, are used to dispense marking material on, for example, the surface of the ground at the location of the facility in order to communicate the presence or absence of a facility or facilities to an excavator. In one example, marking materials may comprise paint, chalk, dye, iron, or any other type of material that would be understood to one having ordinary skill in the art. A locate receiver, such as locate receiver 714, is an instrument for detecting facilities that are concealed in some manner, such as cables and pipes that are located underground. A locate receiver detects electromagnetic fields that are emitted from a facility. A signal, or lack thereof, detected by the locate receiver indicates the presence or absence of a facility. The source of the detection signal along the facility may be a locate transmitter, such as locate transmitter 716, that is electrically coupled to the facility. Once the presence or absence of a facility is detected, a marking device, such as marking device 710, may be used to dispense a marking material on, for example, the surface of the ground at the location of the facility in order to indicate the presence or absence of a facility or facilities.

Marking device 710 may be any marking device which is capable of providing information that is useful in activity tracking system 100. Preferably, marking device 710 is a geo-enabled electronic marking device, such as the geo-enabled electronic marking device described in U.S. Patent Publication No. 2009/0327024 entitled “Methods and Apparatus for Quality Assessment of a Field Service Operation,” which is incorporated herein by reference in its entirety. The '024 patent publication describes a geo-enabled electronic marking device that may include input devices, such as, but not limited to, one or more of the following types of devices: a marking material detection mechanism, a location tracking system, a temperature sensor, a humidity sensor, a light sensor, an electronic compass, an inclinometer, an accelerometer, an image capture device, and an audio recorder.

Marking device docking station 712 may be, for example, a vehicle-mounted docking station that is used for securing marking device 710 in a vehicle, such as mechanical equipment 115. Marking device docking station 712 may be a marking device docking station that has processing capability and that also serves as a battery recharging station for marking device 710. In one embodiment, marking device docking station 712 may be the electronic marking device docking station described in U.S. Patent Publication No. 2010/0085694, entitled “Marking device docking stations and methods of using same,” which is incorporated herein by reference in its entirety.

Locate receiver 714 may be any locate receiver device which is capable of providing information to activity tracking system 100. In an embodiment, locate receiver 714 may be a geo-enabled electronic locate receiver device, such as the geo-enabled electronic locate receiver device that is described in the '024 patent publication. The '024 patent publication describes a geo-enabled electronic locate receiver device that may include input devices, such as, but not limited to, one or more of the following types of devices: a location tracking system, a temperature sensor, a humidity sensor, a light sensor, an electronic compass, an inclinometer, an accelerometer, an image capture device, and an audio recorder.

Locate transmitter 716 may be any locate receiver device that is capable of providing information that is useful in activity tracking system 100. According to one aspect, locate transmitter 716 may be a geo-enabled electronic locate transmitter device configured to send and/or receive geo-location information.

Combination locate and marking device 718, which includes RF antenna 720, is a device that has both the functionality of a locate receiver device and the functionality of a marking device integrated into a single device that can be used in locate or other on site operations. Combination locate and marking device 718 may be any combination locate and marking device configured to communicate with activity tracking system 100. In an embodiment, combination locate and marking device 718 is a geo-enabled electronic combination locate and marking device, such as the geo-enabled electronic combination locate and marking device that is described in one or more of the published applications incorporated herein by reference (e.g., U.S. publication no. 2010-0088032-A1, published Apr. 8, 2010, filed Sep. 29, 2009, and entitled, “Methods, Apparatus and Systems for Generating Electronic Records of Locate And Marking Operations, and Combined Locate and Marking Apparatus for Same”).

According to one aspect, combination device 722 may include a location tracking system, an accelerometer, and/or a camera system. In one example, combination device 722 includes two opposite-facing digital video cameras with the location tracking system and accelerometer. In another example, combination device 722 may be an in-vehicle system such as a DriveCam device from DriveCam, Inc. (San Diego, Calif.), a SmartRecorder device from SmartDrive Systems, Inc (San Diego, Calif.), a Kolimat RoadScan Drive Recorder DE Series device from Kolimat USA LCC (Brooklyn, N.Y.), or other devices that would be understood by one having ordinary skill in the art as providing the same or similar features.

Inclinometer 724, which is an instrument configured to measure angles of slope (or tilt) or inclination of an object with respect to gravity, may be any commercially available inclinometer device. In one example, inclinometer 724 may be a multi-axis digital device for sensing the inclination of the device in which it is installed.

An accelerometer is a device for measuring acceleration and gravity-induced reaction forces. A multi-axis accelerometer is able to detect magnitude and direction of the acceleration as a vector quantity. The acceleration specification may be in terms of g-force, which is a measurement of acceleration. Accelerometer 726 may be any commercially available accelerometer device, such as a 3-axis accelerometer. In one example, accelerometer 726 may be utilized to determine the motion (e.g., rate of movement) of the device in which it is installed.

Electronic compass 728 may be any commercially available electronic compass for providing the directional heading of a device in which it is installed. The heading means the direction toward which electronic compass 728 is moving, such as north, south, east, west, and combinations thereof.

Digital camera 730 may be any image capture device that provides a digital output, such as any commercially available digital camera. The digital output of digital camera 730 may be stored in any standard or proprietary audio file format (e.g., JPEG, TIFF, BMP, etc.). Similarly, digital video camera 732 may be a video capture device that provides a digital output, such as any commercially available digital video camera.

360-degree camera 734 may be any digital camera system that is capable of capturing a 360-degree panoramic view. In one example, 360-degree camera 734 may be a 360 degree panoramic digital video camera, which may provide a digital video output that may include any number of individual frames suitable to substantially indicate a panoramic view. In another example, the 360-degree camera 734 may be a single digital camera that is capable of rotating around a substantially fixed axis and taking a series of individual images that are suitable to substantially provide a panoramic view. In yet another example, the 360-degree camera 734 may be multiple digital cameras (e.g., 7 cameras) that are arranged in a radial fashion around a common position to collectively capture a panoramic view.

Digital audio recorder 736 may be any audio capture device that provides a digital output, such as any commercially available digital audio recorder. Microphone 738 may be associated with digital audio recorder 736. The digital output may be stored in any standard or proprietary audio file format (e.g., WAV, MP3, etc.).

A cell phone (also called cellular phone and mobile phone) is an electronic device used for mobile telecommunications or data communications over a cellular network. Cell phone 740 may be any commercially available cell phone.

IR camera 742 may be any infrared camera, which is a device that forms an image using infrared radiation (e.g., a thermal imaging device).

Dead reckoning is the process of estimating present position by projecting course and speed from a known past position. An Inertial Navigation System (INS) is a dead reckoning type of navigation system that computes its position based on motion sensors. Once the initial latitude and longitude is established, the INS receives impulses from motion sensors (e.g., accelerometers) and rotation sensors (i.e., gyroscopes) to continuously calculate via dead reckoning the position, orientation, and velocity (direction and speed of movement) of a moving object without the need for external references. Dead reckoning device 744 may be any device that is suitable to implement a dead reckoning type of navigation system. For example, dead reckoning device 744 may include motion sensors (e.g., accelerometers) and rotation sensors (i.e., gyroscopes). Dead reckoning device 744 may be a device that is wearable by a person, such as locate field technician 114. In another example, dead reckoning device 744 may be a device that is installed in or on any other system 210, source 214, sensor 216, and/or device 218 configured to communicate with activity tracking system 100.

Personal sensing device 746 may be any wearable sensing device that is capable of providing information that is useful in activity tracking system 100 for chronicling the activities of field technicians 114. In one example, personal sensing device 746 may be a glove-like input device (also called wired glove and data glove), such as those used in virtual reality environments. Various sensor technologies are used to capture physical data such as bending of fingers. In an embodiment, a motion tracker, such as a magnetic tracking device or inertial tracking device, may be attached to capture the global position/rotation data of the glove. These movements are then interpreted by the software that accompanies the glove, so any one movement can mean any number of things. Gestures can then be categorized into useful information. Examples of glove-like input devices include the DataGlove device by Sun Microsystems, Inc (Santa Clara, Calif.) and the CyberGlove device by CyberGlove device LLC (San Jose, Calif.). In another embodiment, personal sensing devices 746 may include any number or type of biosensors 748. For example, biosensors 748 may include one or more of the following types of biosensor devices: a heart rate sensor, a blood pressure sensor, a body temperature sensor, or other types of biosensors to monitor, record, or transmit data.

Referring to FIGS. 1 through 7, with respect to data sources 122, each individual system 210, individual computer application 212, individual source 214, individual sensor 216, and/or individual device 218 is not limited to being an autonomous entity and is not limited to the examples shown in FIGS. 1 through 7. For example, device 218 can be a device that includes sensor 216, or system 210 can be a data source system that includes source 214. More specifically, the entities (e.g., system 210, computer application 212, source 214, sensor 216, or device 218) can be individual entities or can be combined with each other to function as data sources 122 of activity tracking system 100.

Additionally, individual data streams 126 that originate from the individual systems 210, individual computer applications 212, individual sources 214, individual sensors 216, and/or individual devices 218 may be collected, stored, and processed independently of any other data streams 126 of any other systems 210, computer applications 212, sources 214, sensors 216, and/or devices 218. Further, the individual data streams 126 may be, for example, a daylong data stream that may reflect both the active and inactive times of the originating systems 210, computer applications 212, sources 214, sensors 216, and/or devices 218.

In some embodiments, individual data streams 126 may be associated with other data streams 126 by any means. For example, two or more data streams 126 may be associated by physical proximity (i.e., per geo-location data), by originating from a common instrument or tool (e.g., data streams 126 originating from the marking device), by related functions and/or uses (e.g., marking device and locate receiver), and the like. Associated data streams 126 may include tags that indicate associations.

Additionally, individual data streams 126 that originate from the any of systems 210, computer applications 212, sources 214, sensors 216, and/or devices 218 may be associated with a user, such as field technician 114. This is because the data streams 126 can originate from data sources 122 that are assigned to, used by, and/or otherwise associated with specific field technicians 114. In this way, data streams 126 allow person-based and time-oriented records of activity to be generated with respect to locate or other on site operations. In one example, when data streams 126 are stored on a computer 110 they may be tagged with a field technician ID number and/or a vehicle ID number. Other useful information, such as the current work order number, may be appended to the data streams 126. In one embodiment, data streams from more than one field technician 114 can be merged into a single data stream 126. The merged data stream in this example can indicate the activities of multiple field technicians 114.

FIG. 8 shows examples of timelines 800, which represent a portion of data streams 126 of data sources 122 of activity tracking system 100. Each data source 122 of activity tracking system 100 may provide a time-oriented data stream 126. In one embodiment, each acquisition of raw data that comprises each data stream 126 includes a timestamp (i.e., date and/or time information). The timestamp information may be applied by the data-generating entity and/or applied by the data-receiving entity. Each acquisition of raw data associated with a data stream 126 may be generally referred to as a data acquisition event. By processing data streams 126 based on timestamp information, the one or more timestamped data acquisition events that form each data stream 126 may be represented in a sequential timeline fashion, as shown in FIG. 8. In the example shown in FIG. 8, timelines 800 are intended to show a common 15-minute window of multiple data streams 126. The timelines 800, or other visual representations of acquisition events can be provided for display at display device 176 (e.g., to field technician 114) or to display device 178 (e.g., to a supervisor). For example, the computer 110 can generate timeline 800 from data streams 126 and provide the timelines 800 to the central server 112 via the network 124 for display at the display device 178 of the central server 112. In another example, computer 110 provides the data streams 126 to the central server 112, and the central server 112 generates the timelines 800 based on the data streams 126.

According to an embodiment, the amount of data associated with data streams 126 of data sources 122 of the activity monitoring system may relate to a predetermined master timeline generated by activity tracking system 100. In one example, the master timeline may correlate to a “daylong” stream of data with respect to the activities of field technicians 114. This daylong master timeline may be defined as, for example, 7:00 am to 7:00 pm of a calendar day, midnight of one calendar day to midnight of the next calendar day, the first clock-in event to the last clock-out event of a calendar day, the first vehicle ignition ON to the last vehicle ignition OFF of a calendar day, the first activation of the data-collecting entity (e.g., first activation of computer 110) to the last deactivation of the data-collecting entity (e.g., last deactivation of computer 110) in a calendar day, the first data collection event logged by the data-collecting entity (e.g., computer 110) to the last data collection event logged by the data-collecting entity in a calendar day, or any other timeline associated with the processing of one or more data streams 126 according to a master timeline generated by activity tracking system 100.

In one example, data processing application 128 of computer 110 may process data streams 126 to generate timelines 800, which may be based on the master timeline. Timelines 800 may reflect both the active and inactive times of the originating data source 122. By way of example, FIG. 8 shows a timeline 810, which represents a portion of the data stream 126 of a first data source 122; a timeline 815 which represents a portion of the data stream 126 of a second data source 122; a timeline 820, which represents a portion of the data stream 126 of a third data source 122; a timeline 825, which represents a portion of the data stream 126 of a fourth data source 122; and a timeline 830, which represents a portion of the data stream 126 of a fifth data source 122.

Timelines 810, 815, 820, 825, and 830 represent, for example, a 15-minute window of their corresponding “daylong” data streams 126. Further, the 15-minute window of timelines 810, 815, 820, 825, and 830 may be the same 15-minute window of the “daylong” data streams 126. For example, timelines 810, 815, 820, 825, and 830 may represent the 15-minute window of 10:00 am to 10:15 am of the corresponding “daylong” data streams 126.

A number of data acquisition events (e.g., E1, E2, E3, and so on) are shown along timelines 810, 815, 820, 825, and 830. For example, timeline 810 of the first data source 122 indicates that five data acquisition events (i.e., E1 through E5 randomly spaced) were logged in this particular 15-minute window of time. Timeline 815 of the second data source 122 indicates that nine data acquisition events (i.e., E1 through E9 randomly spaced) were logged in this particular 15-minute window of time. Timeline 820 of the third data source 122 indicates that twelve data acquisition events (i.e., E1 through E12 randomly spaced) were logged in this particular 15-minute window of time. Timeline 825 of the fourth data source 122 indicates that no data acquisition events were logged in this particular 15-minute window of time. Timeline 830 of the fifth data source 122 indicates that many data acquisition events (e.g., E1 through E840 evenly spaced) were logged in this particular 15-minute window of time. With respect to timeline 830, the data acquisition events (E) thereof may represent data that was returned from its corresponding data source 122 at a substantially constant rate. For example, the data may be returned every one second of this 15-minute window of time, which results in data acquisition events E1 through E900 (i.e., 60 seconds×15 minutes=900 events) logged along timeline 830.

In an embodiment, data processing application 128 of computer 110 may be configured to process the contents of one or more data streams 126 that are returned from data sources 122 with respect to chronicling the activities of field technicians 114. For example, data processing application 128 may render each daylong data stream 126 to a timeline, such as timelines 800 of FIG. 8. Data processing application 128 may provide, for example, the capability to overlay the information of any combination of one or more timelines (i.e., one or more data streams 126) for chronicling the activities of field technicians 114 to provide a correlation or reference between two or more data streams 126 received by data processing application 128. A visual representation (e.g., a graphical image) representing the timeline or other information overlayed onto a graphical image can be displayed on the display device 176 (e.g., to the field technician 114) or on the display device 178 (e.g., to a supervisor). The visual representation can be generated by the processing unit 116 of the computer 110, or the data streams 126 can be provided from the computer 110 to the central server 112 and the processing unit 182 can execute the data processing application 160 to generate visual representations of field service activity at the central server 112.

In this way, an embodiment of activity tracking system 100 may facilitate the collection of useful information with respect to chronicling the activities of field technicians 114. While the activities of field technicians 114 may be chronicled by processing data streams 126 from a large number of data sources 122, types of activities of technicians that may be chronicled by processing data streams 126 may be as indicated in the following exemplary activity listings:
1) usage and/or activities of time-keeping application 410—such as clock-in/clock-out or other events that may include associated geo-location information;
2) usage and/or activities of electronic work order viewer 412—beginning times, ending times, and durations of viewing electronic on site operation work orders;
3) usage and/or activities of facilities maps viewer 414—beginning times, ending times, and durations of viewing facilities maps;
4) usage and/or activities of viewer application 416—beginning times, ending times, and durations of viewing text and/or graphics;
5) usage and/or activities of VWL application 418—beginning times, ending times, and durations of viewing VWL images 420;
6) usage and/or activities of EM application 422—beginning times, ending times, and durations of processing EM images 424;
7) usage and/or activities of location tracking systems (e.g., location tracking system 314) that are installed in any equipment associated with technicians—equipment locations, equipment location durations, equipment movements, equipment movement durations, and the like;
8) usage and/or activities of telematics system 312 that is installed in mechanical equipment 115—travel routes, travel time durations, travel idle time, idle time locations, locate site arrival times, locate site departure times, locate site durations, and the like;
9) usage and/or activities of marking device docking station 712—times that marking device 710 is present therein and/or absent therefrom;
10) usage and/or activities of marking device 710 e.g., geo-enabled electronic marking device that may include one or more of the following types of devices: a marking material detection mechanism, a location tracking system, a temperature sensor, a humidity sensor, a light sensor, an electronic compass, an inclinometer, and an accelerometer—marking start times; marking end times; marking durations; marking device settings; marking details, such as, but not limited to, number of device actuations, durations of device actuations, location of device actuations, color of marking material; ambient temperature; ambient humidity; ambient light; and the like;
11) usage and/or activities of locate receiver 714 e.g., geo-enabled electronic locate receiver device that may include one or more of the following types of devices: a location tracking system, a temperature sensor, a humidity sensor, a light sensor, an electronic compass, an inclinometer, and an accelerometer—locating start times, locating end times, locating durations, locate receiver settings, locate receiver readings, temperature, ambient humidity, ambient light, and the like;
12) usage and/or activities of locate transmitter 716—transmitter start times, transmitter end times, transmitter durations, transmitter settings, and the like;
13) usage and/or activities of tools 510, equipment 512, and/or instrumentation 514—usage start times, usage end times, usage durations, any locations thereof, any movement thereof, any settings thereof, any readings thereof, usage of safety equipment, and the like;
14) usage and/or activities of mobile operations pod 516—usage start times, usage end times, usage durations, any locations thereof, any movement thereof, any settings thereof, any readings thereof, and the like;
15) usage and/or activities of media capture devices (e.g., digital camera 730, digital video camera 732, 360-degree camera 734, and digital audio recorder 736) that are installed in equipment associated with technicians—image capture times, video capture times, video durations, audio capture times, audio durations, and the like.
16) usage and/or activities of dead reckoning devices (e.g., dead reckoning device 744) that are installed in any equipment associated with technicians—equipment locations, equipment location durations, equipment movements, equipment movement durations, and the like;
17) usage and/or activities of dead reckoning devices (e.g., dead reckoning device 744) that are worn by technicians—technician locations, field technician location durations, technician movements, technician movement durations, and the like;
18) usage and/or activities of personal sensing devices (e.g., personal sensing device 746) that are worn by technicians—technician movements, technician movement durations, and the like; and
19) usage and/or activities of cell phones (e.g., cell phones 740) that are used by technicians—cell phone usage start times, cell phone usage end times, cell phone usage durations, cell phone usage frequency, numbers called, text message usage, and the like.

An embodiment of activity tracking system 100 also may facilitate the accurate performance of work duties by applying business rules to individual events or data processing streams. Such business rules may be configurable to allow users, such as supervisors, to add additional prompts that need to be answered by employees completing certain tasks. Certain prompts may have defined answers, and certain other prompts may be optional, based on the amount of information required for the specific activity. One business rule of activity monitoring system 100 may process data using time clock logic that matches clock-in/clock-out information, disallows certain entry types when not appropriate, and identifies and reporting discrepancies, such as missed activities.

Activity tracking system 100 also may include rules related to state or local rules or regulations related to time worked. For example, jurisdictions may mandate the number and/or length of breaks during the work day or the amount of time between shifts, so one or more rules applied by activity tracking system 100 may ensure that employees' actions do not violate such regulations. If an employee's activity information indicates that the employee is attempting the violate such regulations, activity tracking system 100 may allow the employee to provide information about the reason for the violation, which may be transmitted to a supervisor for review.

Additional rules may manage the activities displayed to employees, such that employees are only able to select activities based on the work order or their determined location. As discussed previously, however, if an employee attempts to violate such conditions by selecting a different activity, the employee may provide a description or reason for the activity, which may be reviewed by a supervisor.

Activity tracking system 100 also may include one or more business rules configured to allow certain users, such as crew foremen, to review activity information processed by activity tracking system 100 from employees before the information is transmitted to supervisor-level. Similarly, supervisor-level employees should have access to the processed and reviewed information before it is, for example, exported to a billing system operatively connected to activity tracking system 100. The business rules can grant different permissions to different workers. For example, a supervisor can have access to field technician activity or other information that field technicians cannot, in this example, access.

Tables 1 and 2 below show additional examples of a portion of the contents of data streams 126 of data sources 122 with respect to a chronicling of the activities of a technician, such as field technician 114. Further, the information shown in Tables 1 and 2 is an example of person-based and time-oriented records of activity with respect to on site (e.g., locate) operations according to an exemplary embodiment.

TABLE 1
Example contents of data stream 126 that indicates arrival at job
site of first on site (e.g., locate) operation work order of the day.

| Date/Time | Activity |
|---|---|
| 10 Oct. 2009 | Mechanical equipment (e.g. vehicle) information system |
| 7:23:43 | 310 records deceleration (braking) of mechanical |
| | equipment (e.g. vehicle) 115, along with timestamp and |
| | placestamp (i.e., geo-location data). |
| 10 Oct. 2009 | Mechanical equipment information system 310 records |
| 7:23:57 | parking of mechanical equipment 115, along with |
| | timestamp and placestamp. |
| 10 Oct. 2009 | Mechanical equipment information system 310 records |
| 7:23:57 | ignition off event of mechanical equipment 115, along |
| | with timestamp and placestamp. |
| 10 Oct. 2009 | Computer monitoring application 450 of computer 110 |
| 7:24:42 | records time that technician powers on computer 110. |
| 10 Oct. 2009 | Location tracking system 314 on computer 110 records |
| 7:25:30 | the first timestamp and placestamp of the workday. |
| | Subsequent timestamp/placestamp pairs are recorded at |
| | 30 second intervals throughout the periods of the |
| | workday that the technician is working (clocked in). |
| 10 Oct. 2009 | Time-keeping application 410 presents technician with |
| 7:25:44 | the computer power on time as the clock in time for the |
| | workday, and the satellite imagery associated with the |
| | first placestamp of the workday as the clock in location |
| | for the workday. |
| 10 Oct. 2009 | Time-keeping application 410 records the technician |
| 7:26:02 | signature approving the clock in time and location as |
| | depicted with location imagery. |
| 10 Oct. 2009 | Computer monitoring application 450 of computer 110 |
| 7:26:16 | records the timestamp associated with the launching of |
| | work order management application 413. |
| 10 Oct. 2009 | Work order management application 413 and/or electronic |
| 7:26:36 | work order viewer 412 records the timestamp associated |
| | with the field technician 114 viewing the location |
| | operation work order information. |
| 10 Oct. 2009 | Computer monitoring application 450 of computer 110 |
| 7:27:52 | records the timestamp associated with launching facilities |
| | maps viewer 414. |
| 10 Oct. 2009 | Computer monitoring application 450 of computer 110 |
| 7:29:48 | records the timestamp associated with closing facilities |
| | maps viewer 414. |

TABLE 2
Example contents of data stream 126 that indicates locate activity
of a on site (e.g., locate) operation work order

| Date/Time | Activity |
|---|---|
| 10 Oct. 2009 | Marking device 710 records the technician action of |
| 10:18:23 | depressing the actuator, including timestamp, placestamp, |
| | location relative to mechanical equipment 115, marking |
| | material serial number and color. |
| 10 Oct. 2009 | Marking device 710 senses and records a series of |
| 10:18:48 | technician movement actions with the device, including |
| | timestamp, placestamp, location relative to mechanical |
| | equipment 115, and movement/acceleration rates and |
| | direction. |
| 10 Oct. 2009 | Marking device 710 records the technician action of |
| 10:19:19 | releasing the actuator, including timestamp, placestamp, |
| | location relative to mechanical equipment 115, marking |
| | material serial number and color. |
| 10 Oct. 2009 | Marking device 710 provides an indicator to the |
| 10:19:39 | technician that the technician is outside of an established |
| | range of the VWL image 420 region. The event is |
| | recorded, including timestamp, placestamp, and location |
| | relative to mechanical equipment 115. |
| 10 Oct. 2009 | Marking device 710 records the technician action of |
| 10:19:41 | completion of marking, including timestamp, placestamp, |
| | and location relative to mechanical equipment 115. |
| 10 Oct. 2009 | EM application 422 receives the results of marking device |
| 10:19:49 | 710 activity, including depictions, categorization and |
| | annotations associated with the facility assets indicated by |
| | the markings. The timestamp of data receipt is recorded. |
| 10 Oct. 2009 | EM application 422 launches the user interface on |
| 10:20:44 | computer 110 and prepares the initial manifest for |
| | presentation to the technician based upon the results of |
| | marking activity. The timestamps associated with the |
| | start/completion of the manifest preparation processes |
| | are recorded. |
| 10 Oct. 2009 | EM application 422 stores the timestamp/placestamp |
| 10:21:03 | associated with the arrival of the technician at computer |
| | 110 as evidenced by the unlocking of the device. |
| 10 Oct. 2009 | EM application 422 stores additional annotations as |
| 10:22:13 | entered by the technician as an additional layer to the |
| | original marking layer. The timestamp/placestamps |
| | associated with the annotation completions are recorded. |
| 10 Oct. 2009 | EM application 422 stores the manifest approval actions |
| 10:22:49 | performed by the technician. The timestamp/placestamps |
| | associated with the approval actions are recorded. |
| 10 Oct. 2009 | Work order management application 413 stores the locate |
| 10:23:16 | task review/approval actions performed by the technician. |
| | The timestamp/placestamps associated with the locate |
| | approval actions are recorded. |
| 10 Oct. 2009 | Computer monitoring application 450 of computer 110 |
| 10:23:33 | records the timestamp/placestamps associated with |
| | closing work order management application 413. |
| 10 Oct. 2009 | Computer monitoring application 450 of computer 110 |
| 10:23:55 | records timestamp/placestamps associated with |
| | technician locking computer 110. |
| 10 Oct. 2009 | Mechanical equipment information system 310 records |
| 10:24:23 | ignition start event of mechanical equipment 115, along |
| | with timestamp and placestamp. |
| 10 Oct. 2009 | Mechanical equipment information system 310 records |
| 10:24:33 | drive transmission action of mechanical equipment 115, |
| | along with timestamp and placestamp. |
| 10 Oct. 2009 | Mechanical equipment information system 310 records |
| 10:24:41 | acceleration of mechanical equipment 115, along with |
| | timestamp and placestamp. |

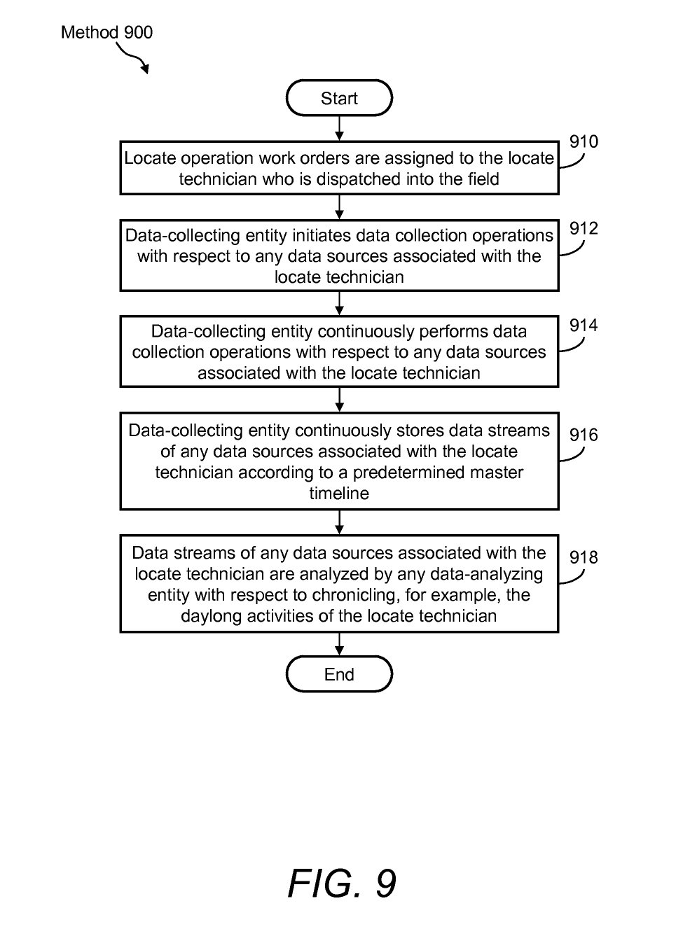

FIG. 9 is a flow diagram of a method 900 for collecting and processing data streams for chronicling the activities of one or more technicians. By way of example, method 900 is described with reference to FIG. 1 for chronicling the activities of field technician 114 who is using computer 110 and mechanical equipment 115. Method 900 may include, but is not limited to, the following steps, which are not limited to any order.

In step 910, operation work orders are assigned to the technician who is dispatched into the field. For example, operation work orders in electronic form may be received at computer 110 and reviewed by field technician 114.

In step 912, the data-collecting entity may initiate data collection operations with respect to data sources associated with the technician. In one embodiment, the data-collecting entity may be computer 110, which initiates the data collection operations with respect to data sources 122 that are associated with field technician 114.

In step 914, the data-collecting entity may continue to perform data collection operations with respect to data sources associated with the field technician 114. According to one aspect, computer 110 continuously performs data collection operations with respect to data sources 122 associated with field technician 114. More specifically, when data source 122 is active and capable of returning information to computer 110 at any time during the day of activity of field technician 114, the information that is returned may be compiled into its corresponding data stream 126 for that day. In one example, the data collection operations and the management of data streams 126 may be performed by data processing application 128 of computer 110.

In step 916, the data-collecting entity continuously stores the data streams of data sources associated with the field technician 114 according to a predetermined master timeline. For example, computer 110 may continuously store in local memory 118 the data streams 126 of any data sources 122 that are associated with field technician 114 according to a predetermined master timeline. If the master timeline is 7:00 am to 7:00 pm of the calendar day, data streams 126 may be processed to include only that information which is collected from 7:00 am to 7:00 pm of the calendar day. In an embodiment, the processing of data streams 126 with respect to the predetermined master timeline may be performed by data processing application 128 of computer 110. In an embodiment, processing may include associating data streams 126 with field technician 114 based on data sources 122 being assigned to, used by, or otherwise connected to field technician 114. As such, information related to the processing of data streams 126 according to the master timeline may be associated with field technician 114.

In step 918, the data streams of data sources associated with the field technician 114 are analyzed by the data-analyzing entity with respect to chronicling, for example, the daylong activities of the field technician 114. In an embodiment, data processing application 128 of computer 110 may be the data-analyzing entity. In another embodiment, information in at least one data stream 126 of data sources 122 may be transferred from computer 110 to another computing device for processing.

Continuing step 918, the data-analyzing entity, such as data processing application 128, analyzes data streams 126 of at least one data source 122 that is assigned to, used by, and/or otherwise associated with field technician 114 with respect to chronicling the activities of field technician 114 for the calendar day. For example, timelines, such as timelines 800 of FIG. 8, may be generated for data stream 126 of data source 122. The data stream 126 of data source 122 may be analyzed with respect to the data streams 126 of one or more other data sources 122 for any purpose. The purpose of this analysis may be, but is not limited to, the following: (1) for storing a record of the activities of field technician 114 for the calendar day, (2) for verifying the activities of field technician 114 for the calendar day, (3) for making observations about the activities of field technician 114 for the calendar day, (4) for drawing conclusions about the activities of field technician 114 for the calendar day, and (5) any combinations thereof.

Referring to FIG. 10, a flow diagram of an example of a method 1000 of operation of activity tracking system 100 is presented. An aspect of activity tracking system 100 and method 1000 is the capability to associate and log clock in/out activity with respect to geo-encoded images (e.g., input images 132). Method 1000 may include, but is not limited to, the following steps, which are not limited to any order.

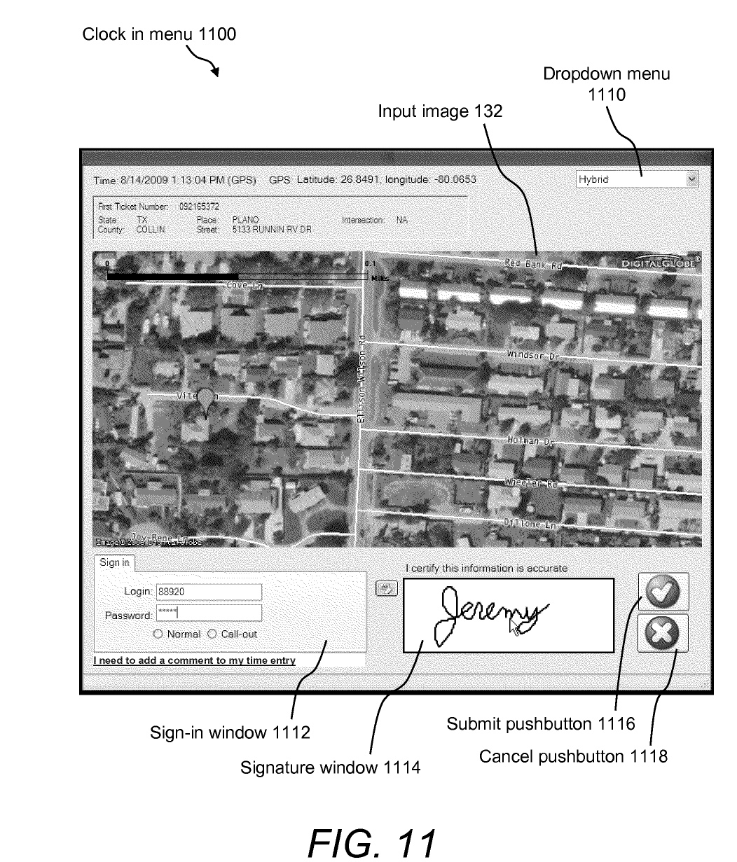

At step 1010, a clock in process is performed using activity tracking system 100 to identify a user's (e.g., field technician 114) current location based at least in part on a geo-encoded image. For example, when the user reaches the location of the first work order of the day, a clock-in process is automatically initiated by which the user is automatically prompted to clock in. A clock-in menu, such as the menu shown in FIG. 11, may be displayed to the user.

Referring to FIG. 11, an example of a clock-in menu 1100 of activity tracking system 100 is presented. Clock-in menu 1100 is an example of a GUI menu 431 of time tracking client application 430. Clock-in menu 1100 may be configured to contain text fields that display, for example, the current time, the current geo-location (e.g., GPS latitude and longitude coordinates), current work order information, or other information associated with the user's (e.g., field technician 114) current location or activity. In one embodiment, to calculate the current geo-location, time tracking client application 430 may be configured to query location tracking system 314 of computer 110. If the current geo-location cannot be determined from location tracking system 314, time tracking client application 430 may be configured to attempt to correct the problem or may alert the user. For example, an alert provided to the user may request that the user contact a help desk for further assistance in resolving the locating/tracking issue. In this example, the clock-in process of step 1010 may include the amount of time required to resolve the location-tracking issue.

In another aspect, clock-in menu 1100 may be configured to display image data associated with the current geo-location of the field technician 114 or other user. For example, clock-in menu 1100 may include an aerial image retrieved via image server 130 that corresponds to the user's current location as stated by the user or as determined by the time tracking client application 430. According to another aspect, a dropdown menu 1110 of clock-in menu 1100 may be configured to allow the user to select the type of image associated with the clock-in event. For example, dropdown menu 1110 may include a road view selection, a satellite view selection, and/or a hybrid view selection. FIG. 11 depicts an example of a hybrid view where street names are overlaid upon a satellite view. A “tear-drop” icon on an input image 132 may be provided to indicate the user's current location.

At step 1010, during the clock-in operation, the current time is stored as the “start time” in local memory of computer 110. For example, during the clock in process, the field technician 114 or other user may be prompted to enter the type of work they are clocking in for (e.g., normal or call out) via a “normal” or “call out” checkbox of clock-in menu 1100. Additionally, when the type of work is “normal,” the user may be presented with a “pick-list” that may include, for example, Start of Day, Return from Break, and/or Return from Lunch. As discussed previously, a selection by the user may trigger a query of the GPS data from location tracking system 314 associated with computer 110 and may log the current time and geo-location in local memory of computer 110.

Referring again to clock-in menu 1100, because the user is performing a clock in operation, clock-in menu 1100 is configured to display a sign-in window 1112 by which the user may input a UserID and password. Clock-in menu 1100 may also include a signature window 1114, to facilitate a signature input from the user, a submit button 1116, and/or a cancel button 1118. Based on the clock-in operation, a time entry manifest may be generated and transmitted to time tracking management application 170 installed on central server 112, thereby providing a mechanism for real-time tracking of any particular field technicians 114 by supervisors. A central server time entry manifest 172 or client time entry manifest 432 that is associated with each clock event of activity tracking system 100 is described with reference to FIG. 12.

FIG. 12 illustrates an exemplary time entry manifest 172 in greater detail. It should be understood that although such features will be described with respect to the central server time entry manifest 172, similar features may be provided in a client time entry manifest 432. A time entry manifest 172 may be configured to include data such as the geo-location, time, and other actions from each time entry event, an image file associated with the time entry, and/or a signature. Additional information, such as textual information regarding the last work order closed may also be provided within a time entry manifest. Information regarding the last work entry closed may also include a representation based at least in part on the location of the last work order that may be added to the image associated with the entry. In an embodiment, a time entry manifest may also include the distance between the last work order 152 closed and the user's location at clock out.

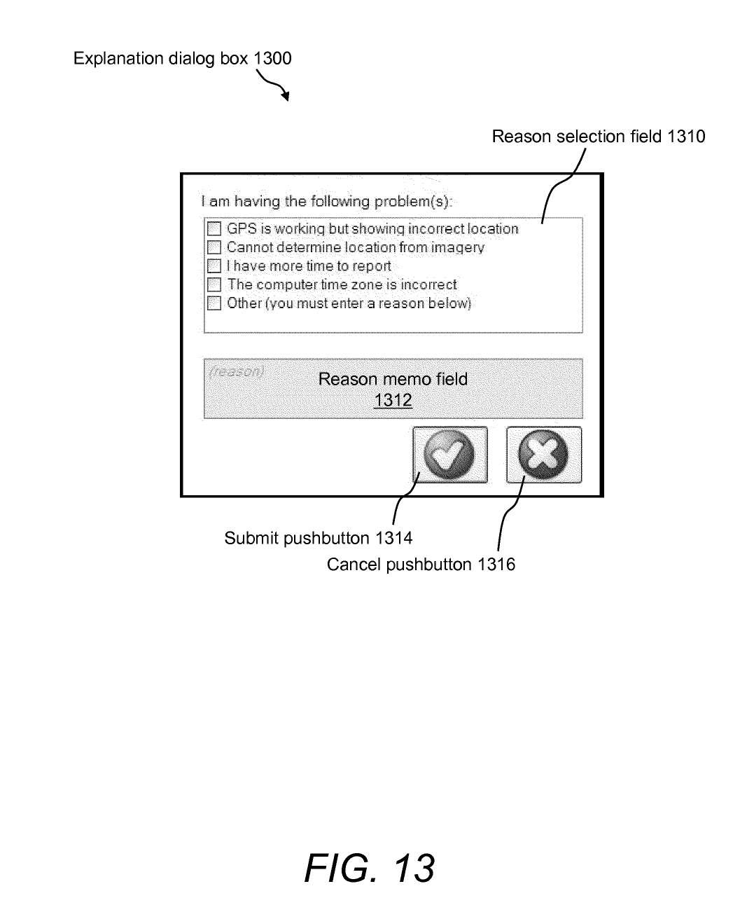

At step 1012, in the event that a clock-in problem occurs at any time during clock step 1010, the activity tracking system 100 may be configured to allow the user (e.g., field technician 114) to provide a comment regarding the clock-in entry. For example, the activity tracking system 100 may provide a link in click-in menu 1100 that allows the user to add a comment. By selecting this link, a window may open to allow the user to choose from a list of possible problems or issues that may be documented. For example, if the user is having difficulties during the clock in process of step 1010 (e.g., geo-location information does not precisely represent the user's actual location) or the user wishes to explain something concerning the time entry (e.g., the user has a valid business reason for being at the current location), the user clicks the “I need to add a comment to my time entry” link, which may open an explanation dialog box, such as the explanation dialog box shown in FIG. 13.

Referring to FIG. 13, an example of an explanation dialog box 1300 of activity tracking system 100 is presented. Explanation dialog box 1300 is another example of a GUI menu 431 of time tracking client application 430. Explanation dialog box 1300 may include a reason selection field 1310, which may include a “pick-list” of reasons, and a reason memo field 1312. Reason memo field 1312 may be disabled and hidden until the user checks a reason box in reason selection field 1310 that requires an entry in reason memo field 1312. Explanation dialog box 1300 also includes a submit pushbutton 1314 and a cancel pushbutton 1316.

Once field technician 114 or other user has successfully clocked in, a task tray icon may be displayed on the system tray of computer 110 to indicate that the user is currently “on the clock,” for the work day or for a particular work order. However, when the user needs to clock out for a short period of time, such as for a lunch break, the user may double click on a clock-out icon provided within a graphical user interface of computer 110. In an embodiment, an icon may be provided on the system tray of a graphical user interface of computer 110. This action initiates the clock out process.

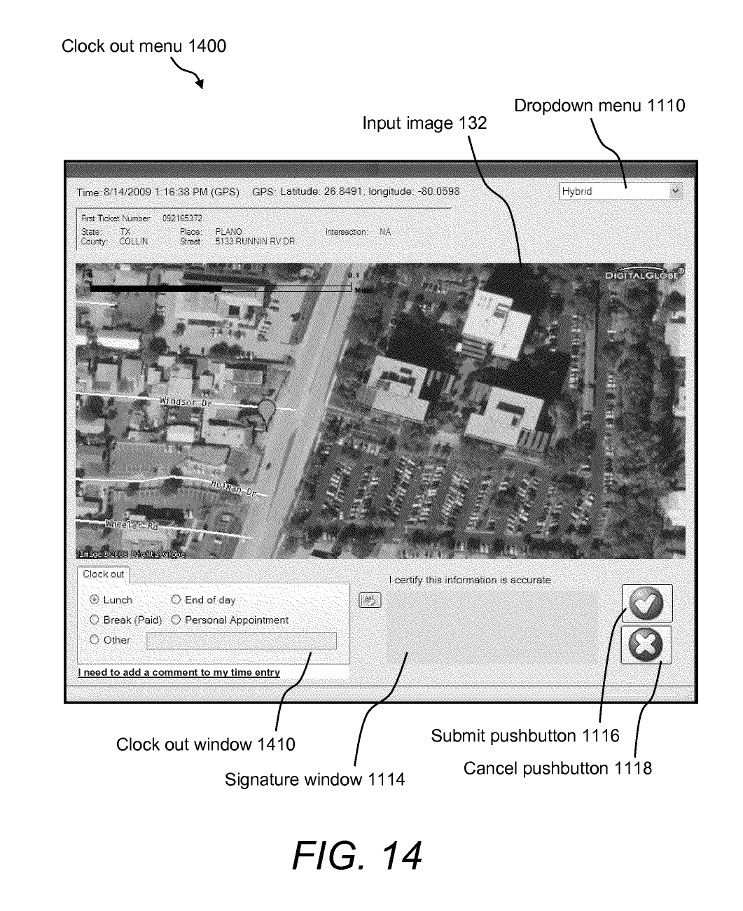

At step 1014, a clock out process is performed using time tracking system 100 of the present disclosure, wherein the user's location is indicated on a geo-encoded image. For example, the user may double click a clock-out icon to generate a clock-out menu, such as the menu shown in FIG. 14.

Referring to FIG. 14, an example of a clock out menu 1400 of activity tracking system 100 is depicted. Clock out menu 1400, as shown, is an example of a GUI menu 431 of time tracking client application 430. In an embodiment, clock out menu 1400 may appear substantially similar to clock-in menu 1100 of FIG. 11, except that it may be configured to include a clock-out window 1410 instead of a sign-in window 1112. According to one aspect, clock-out window 1410 includes a “pick-list” of reasons for clocking out. For example, the “pick-list” may include Lunch, End of day, Break (paid), Personal appointment, and Other options that allow the field technician 114 or other user to select an appropriate reason for clocking out.

In an embodiment, when “Personal appointment” is selected from the “pick-list” of clock-out window 1410 of clock out menu 1400, the interface may be configured to capture a reason for which the user is taking a personal appointment. Similarly, the user may be presented with a “pick-list” of choices that includes an option for providing a description if the user selects “Other” as the reason for clocking out.

In addition, in one embodiment, lunch is taken on the user's time, not the company's time. Therefore, when “Lunch” is selected from the “pick-list” of clock-out window 1410 of clock out menu 1400, time tracking client application 430 may be configured to detect location information associated with the clock-out event. For example, time tracking client application 430 may detect whether the user is clocking in or out at a location that is different than the last work order 152 that was closed. Clock-out window 1410 and the corresponding time entry manifest 222 indicate the location of the last work order 152 that was closed prior to clocking out.

At 1016, time tracking client application 430 determines whether the “End of day” option is selected from the “pick-list” of clock-out window 1410 of clock out menu 1400. If “End of day” is not selected, method 1000 may proceed, for example, to step 1418. However, if “End of day” is selected, method 1000 may proceed, for example, to step 1020.

At step 1018, the current time may be stored as the “end time” in local memory. In an embodiment, this function of time tracking client application 430 causes a query of the GPS time from location tracking system 314 and logs the current time and geo-location in local memory of computer 110. A time entry manifest 432 for this clock-out operation may be created and transmitted to central server 112 for storage and/or further processing, thereby providing a mechanism for real-time tracking of any particular field technicians 114 by supervisors. As discussed previously, an exemplary time entry manifest 222 capture for clock events of activity tracking system 100 is provided in FIG. 12.

Continuing step 1018, once the user (e.g., field technician 114) clicks on submit pushbutton 1116 of clock-out window 1410, time tracking client application 430 may be locked, whereby all interactions with portable computer 110 are disabled except for interaction with the clock in menu, such as clock-in menu 1100 of FIG. 11. In an embodiment, the user may return at any time to the clock in process, via clock-in menu 1100 to initiate a clock-in process, such as step 1010, to unlock computer 110.

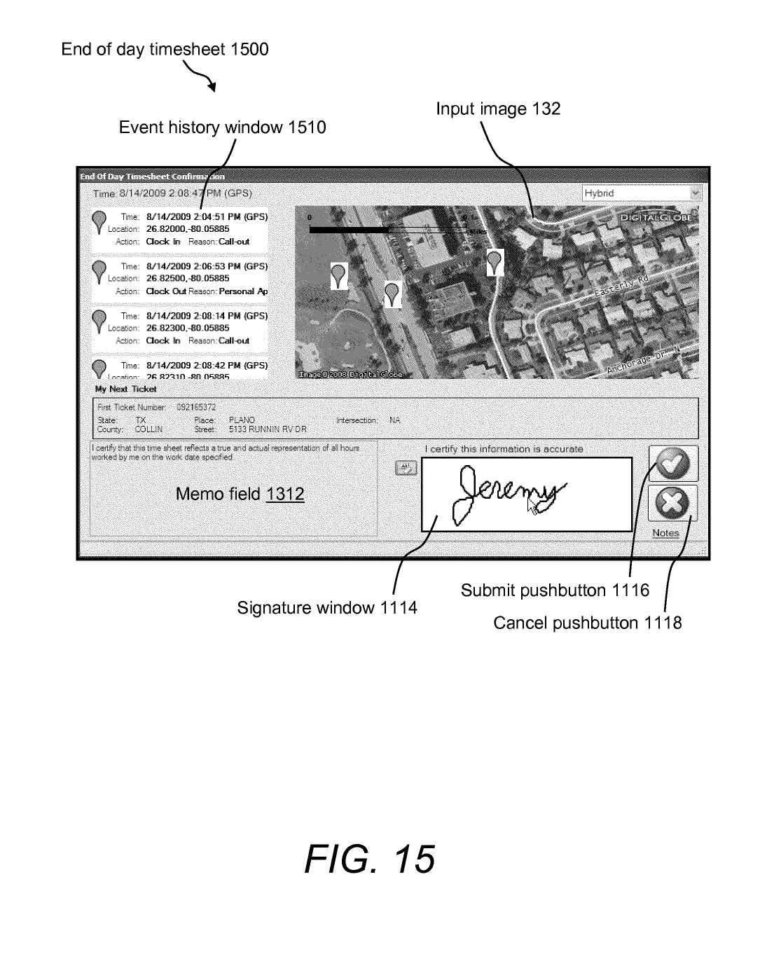

At step 1020, an end of day timesheet, such as the end of day timesheet shown in FIG. 15, may be displayed to the field technician 114 or other user. FIG. 15 illustrates an exemplary end of day timesheet 1500 of activity tracking system 100 that may be presented for review to the user. End of day timesheet 1500 may include one or more input images 132, a signature window 1114, submit pushbutton 1116, and/or cancel pushbutton 1118, as described previously with respect to FIG. 11. End of day timesheet 1500 may be further configured to include an event history window 1510 that may display one or more activity events associated with a particular day. For example, event history window 1510 may be configured to display the entire clock in/out event history for the current day to a user.

In one embodiment, graphical or text-based annotations or markings may be overlaid on input image 132 to indicate locations at which time entries took place during the day. For example, the entire route taken by a field technician 114 for the day may be indicated on input image 132. In another embodiment, input image 132 may include route information, travel information, or other information associated with field technician 114's activities throughout the day. In another embodiment, textual information on end of day timesheet 1500 may indicate information associated with a future or unfulfilled work order, such as work order 152. For example, work order 152 may be the first work order of the next business day that has been provided by central server 112.

At step 1022, the user reviews and signs the “end of day” timesheet, such as end of day timesheet 1500. For example, the user may provide his/her signature in a signature window, such as signature window 1114. In another embodiment, the user may provide additional information regarding the contents of timesheet 1500 via memo field 1512. For example, memo field 1512 may allow a user to provide a note to his/her supervisor regarding the contents of the timesheet. In another embodiment, input image 132 may be configured to provide the user with additional details regarding individual time entries based on one or more inputs from the user.

At step 1024, data may be stored to indicate the end of the normal workday. In one embodiment a normal end of day time may be stored in local memory on computer 110 or may be transmitted to central server 112. In another embodiment, data associated with the end of the normal workday may include time information and/or geo-location information. For example, indicating the end of the workday may include querying location tracking system 314 for current GPS data that may be logged in local memory of computer 110.

At step 1026, a time entry manifest 222 for this end of day clock-out operation, which includes the “end of day” timesheet, such as end of day timesheet 1500, is created and transmitted to central server 112, thereby providing a mechanism for real-time tracking of field technicians 114 by supervisors.

At step 1028, once the user clicks on submit pushbutton 1116 of end of day timesheet 1500, time tracking client application 430 may be configured to automatically log out the user from the client application and the operating system of the computer 110.

In the activity tracking system and method of the present invention each data stream of each data source may be collected, stored, and processed independent of other data streams of any other data sources. In one aspect, each data stream of each data source may be, for example, a daylong data stream that may reflect both the active and inactive times of the originating data source.

The activity monitoring system and method of the present invention may include mechanisms for providing person-based records of activity with respect to operations, as opposed to job-based and/or equipment-based records of activity. When stored, the data streams of the data sources may be associated with specific technicians.

In the activity monitoring system and method of the present invention, the person-based records of activity with respect to work operations may also be time-oriented records. For example, activity information may be organized to display information based on the timing associated with the activity rather than the technician associated with the activity. Aspects of the present invention disclosed herein are intended to provide exemplary descriptions of features related to various possible embodiments of the present invention but are not intended to limit the scope of such embodiments or associated features.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An apparatus for chronicling the activities of at least one technician, the apparatus comprising:
at least one communication interface;
a memory configured to store processor-executable instructions and activity data; and
a processor operatively coupled to the memory and the at least one communication interface, wherein upon execution of the processor-executable instructions, the processor is configured to:
control the at least one communication interface so as to receive field service activity information;
associate at least one data source with the at least one technician;
associate an acquisition event with at least one time window and at least one location based at least in part on received geo-location information;
generate a visual representation of the acquisition event for display at one or more of a display device of a central server and a display device of a computer associated with the at least one technician, wherein the visual representation of the acquisition event is based at least in part on the at least one location; and
generate a timeline associated with the at least one technician and the at least one data source, wherein generating a timeline comprises reconciling the acquisition event with the received field service activity information.

2. The apparatus of claim 1, wherein the visual representation of the acquisition event is associated with a plurality of technicians including the at least one technician.

3. The apparatus of claim 1, wherein the visual representation comprises an overlay of the acquisition event based at least in part on coordinate data associated with the at least one location onto a graphical image.

4. The apparatus of claim 3, wherein the graphical image comprises at least one of an aerial image, a sketched image, a satellite image, a plan image, a street map image, a facility map image, engineering plans, blueprints, tax maps, surveys, and an overlay indicating a point of interest.

5. The apparatus of claim 2, wherein the visual representation comprises an overlay of the acquisition event based at least in part on coordinate data associated with at least two of the plurality of technicians.

6. The apparatus of claim 1, wherein the processor is further configured to provide at least one work order to the at least one technician via a communication interface for display on a display device of a computer associated with the at least one technician.

7. The apparatus of claim 1, wherein the visual representation comprises at least one of a display of a work order and a display of a list of successive work orders, the list of successive work orders indicating an order of operations to perform the successive work orders.

8. The apparatus of claim 1, wherein reconciling the acquisition event with the received field service activity information comprises comparing expected field service activity data with the acquisition event.

9. The apparatus of claim 8, wherein the expected field service activity data comprises at least one of location information, scheduling information, or activity information.

10. An apparatus for chronicling the activities of at least one technician, the apparatus comprising:
at least one communication interface;
a memory configured to store processor-executable instructions and activity data; and
a processor operatively coupled to the memory and the at least one communication interface, wherein upon execution of the processor-executable instructions, the processor is configured to:
determine geo-location information associated with the apparatus;
control the at least one communication interface so as to receive at least one work order;
control the at least one communication interface so as to receive at least one activity input related to the at least one work order;
compare geo-location information associated with the at least one activity input with a location associated with the at least one work order; and
control the at least one communication interface so as to transmit field service activity information, wherein the activity data is based at least in part on the received activity input.

11. The apparatus of claim 10, wherein the processor is further configured to:
control the at least one communication interface so as to receive image data associated with the determined geo-location information;
display the received image data at a display device associated with the at least on communication interface; and
overlay a representation of at least one of the determined geo-location information and the geo-location information associated with the at least one activity onto the received image data.

12. The apparatus of claim 10, wherein the processor is further configured to:
receive at least one activity input that includes location information associated with travel activities between two or more work orders; and
generate a route based at least in part on the received location information associated with travel activities.

13. The apparatus of claim 10, wherein the processor is further configured to:
determine a status indicator of a user associated with the apparatus; and
selectively provide access to a third apparatus based at least in part on the determined status indicator.

14. The apparatus of claim 10, wherein the processor is further configured to receive at least one activity input that includes at least one of a user update and an equipment activity input.

15. A method for chronicling field activities, the method comprising:
receiving field service activity information;
associating at least one data source with at least one technician;
associating an acquisition event with at least one time window and at least one location based at least in part on received geo-location information; and
generating a timeline associated with the at least one technician and at least one data source, wherein generating a timeline comprises reconciling the acquisition event with the received field service activity information.

16. The method of claim 15, further comprising:
generating a visual representation of the at least one acquisition event based at least in part on the at least one location; and
providing the visual representation for display at one or more of a display device of a central server and a display device of a computer associated with the at least one technician.

17. The method of claim 16, wherein the visual representation comprises an overlay of the at least one acquisition event based at least in part on coordinate data associated with the at least one location onto a graphical image.

18. The method of claim 17, wherein the graphical image comprises at least one of an aerial image, a sketched image, a satellite image, a plan image a street map image, a facility map image, engineering plans, blueprints, tax maps, surveys, and an overlay indicating a point of interest.

19. The method of claim 15, further comprising assigning at least one work order to the at least one technician via a communication interface for display on a display device of a computer associated with the at least one technician.

20. The method of claim 15, wherein reconciling the acquisition event with the received field service activity information comprises comparing expected field service activity data with the acquisition event.

21. The method of claim 20, wherein the expected field service activity data comprises at least one of location information, scheduling information, or activity information.

22. A method for activity tracking, comprising:
determining geo-location information associated with a first apparatus;
receiving at least one work order from a second apparatus;
receiving at least one activity input related to the at least one work order;
comparing geo-location information associated with the at least one activity input with a location associated with the at least one work order; and
transmitting field service activity information to the second apparatus, wherein the activity data is based at least in part on the received activity input.

23. The method of claim 22, further comprising:
receiving image data associated with the determined geo-location information;
displaying the received image data; and
overlaying a representation of at least one of the determined geo-location information and the geo-location information associated with the at least one activity onto the received image data.

24. The method of claim 22, wherein receiving at least one activity input related to the at least one work order further comprises:
receiving location information associated with travel activities between two or more work orders; and
generating a route based at least in part on the received location information associated with travel activities.

25. The method of claim 22, further comprising:
determining a status indicator of a user associated with the first apparatus; and
selectively providing access to a third apparatus based at least in part on the determined status indicator.

26. The method of claim 22, wherein receiving at least one activity input comprises receiving at least one of a user update and an equipment activity input.

27. The method of claim 22, wherein the first apparatus is a mobile apparatus.

28. A computer-readable storage medium having computer-executable instructions stored thereon, the instructions comprising:
instructions for receiving field service activity information;
instructions for associating at least one data source with at least one technician;
instructions for associating an acquisition event with at least one time window and at least one location; and
instructions for generating a timeline associated with the at least one technician and at least one data source, wherein generating a timeline comprises reconciling the acquisition event with the received field service activity information.

29. A computer-readable storage medium having computer-executable instructions stored thereon, the instructions comprising:
instructions for determining geo-location information associated with a first apparatus;
instructions for receiving at least one work order from a second apparatus;
instructions for receiving at least one activity input related to the at least one work order;
instructions for comparing geo-location information associated with the at least one activity input with a location associated with the at least one work order; and
instructions for transmitting field service activity information to the second apparatus, wherein the activity data is based at least in part on the received activity input.
